(19) United States
(12) Patent Application Publication
(10) Pub. No.: US 2025/0059845 A1
(43) Pub. Date: Feb. 20, 2025

(54) REMOTE EVALUATION OF SUBSEA WELLHEAD

(71) Applicant: Chevron U.S.A. Inc., San Ramon, CA (US)

(72) Inventors: Wangming Lu, Katy, TX (US); Khiem Nguyen, Fulshear, TX (US); William Stephen Averill, Cypress, TX (US)

(21) Appl. No.: 18/797,180

(22) Filed: Aug. 7, 2024

Related U.S. Application Data
(60) Provisional application No. 63/520,003, filed on Aug. 16, 2023.

(51) Int. Cl. E21B 33/035; G01H 17/00; G05B 23/02

(52) U.S. Cl. CPC E21B 33/035; G05B 23/0235; G01H 17/00

(57) ABSTRACT

A method for remotely evaluating fatigue damage of a subsea wellhead may include obtaining a plurality of values associated with measurements of a parameter associated with the fatigue damage of the subsea wellhead during field operations, wherein the measurements are measured by a sensor device positioned separately from and adjacent to the subsea wellhead; executing an algorithm using the measurements to generate a result; comparing the result of the algorithm with a range of acceptable values; and determining that the subsea wellhead has a potential failure when the result falls outside the range of acceptable values.

### CROSS-REFERENCE TO RELATED APPLICATIONS

This application claims priority under 35 U.S.C. § 119 to U.S. Provisional Patent Application Ser. No. 63/520,003, titled “Remote Evaluation Of Subsea Wellhead” and filed on Aug. 16, 2023, the entire contents of which are hereby incorporated herein by reference.

### TECHNICAL FIELD

The present application is related to subsea wellheads and, more particularly, to remote evaluation of subsea wellheads.

### BACKGROUND

Subsea wellheads used in oil and gas field operations serve critical purposes during various field operations (e.g., drilling). In support of these field operations, a subsea wellhead can be in service for 10 years or more. Over this time, a subsea wellhead is subjected to numerous stresses, causing fatigue damage of the subsea wellhead. If the fatigue damage of a subsea wellhead becomes too severe, the oil and gas field operation may be discontinued to avoid a catastrophic event. In the current art, sensors integrated with subsea wellheads and adjacent equipment are used in an attempt to measure or calculate subsea wellhead fatigue damage. However, due to the harsh environment (e.g., high vibrations, high currents, extreme pressures and temperatures) in which subsea wellheads operate, such sensors often fail. As a result, the current art lacks a reliable, long-term solution for measuring or calculating fatigue damage of subsea wellheads.

### SUMMARY

In general, in one aspect, the disclosure relates to a method for remotely evaluating fatigue damage of a subsea wellhead. The method may include obtaining a plurality of values associated with measurements of a parameter associated with the fatigue damage of the subsea wellhead during field operations, where the measurements are measured by a sensor device positioned separately from and adjacent to the subsea wellhead. The method may also include executing an algorithm using the plurality of values to generate a result. The method may further include comparing the result of the algorithm with a range of acceptable values. The method may also include determining that the subsea wellhead has a potential failure when the result falls outside the range of acceptable values.

In another aspect, the disclosure relates to a system for remotely evaluating fatigue damage of a subsea wellhead. The system may include a sensor device that is configured to measure a parameter associated with the fatigue damage of the subsea wellhead during field operations, where the sensor device is coupled to a host that is positioned separately from and adjacent to the subsea wellhead. The system may also include a controller communicably coupled to the sensor device, where the controller may be configured to obtain a plurality of values associated with measurements of the parameter, wherein the measurements are measured by the sensor device. The controller may also be configured to execute an algorithm using the plurality of values to generate a result. The controller may further be configured to compare the result of the algorithm with a range of acceptable values, where the range of acceptable values is established using prior results of the algorithm. The controller may also be configured to determine that the subsea wellhead has a potential failure when the result falls outside the range of acceptable values.

In yet another aspect, the disclosure relates to a non-transitory computer readable medium comprising computer readable program code, which when executed by a computer processor, enables the computer processor to facilitate obtaining a plurality of values associated with measurements of a parameter associated with fatigue damage of a subsea wellhead during field operations, where the measurements are measured by a sensor device positioned separately from and adjacent to the subsea wellhead; facilitate executing an algorithm using the plurality of measurements to generate a result; facilitate comparing the result of the algorithm with a range of acceptable values; and facilitate determining that the subsea wellhead has a potential failure when the result falls outside the range of acceptable values.

These and other aspects, objects, features, and embodiments will be apparent from the following description and the appended claims.

### BRIEF DESCRIPTION OF THE DRAWINGS

The drawings illustrate only example embodiments and are therefore not to be considered limiting in scope, as the example embodiments may admit to other equally effective embodiments. The elements and features shown in the drawings are not necessarily to scale, emphasis instead being placed upon clearly illustrating the principles of the example embodiments. Additionally, certain dimensions or positions may be exaggerated to help visually convey such principles. In the drawings, the same reference numerals used in different figures may designate like or corresponding but not necessarily identical elements.

FIG. 1 shows a diagram of a subsea field system in which example embodiments may be used.

FIG. 2 shows a block diagram of a system for remotely evaluating subsea wellheads according to certain example embodiments.

FIG. 3 shows a block diagram of another system for remotely evaluating subsea wellheads according to certain example embodiments.

FIG. 4 shows a block diagram of a subsystem for remotely evaluating subsea wellheads according to certain example embodiments.

FIG. 5 shows a front view of a host with multiple sensor devices according to certain example embodiments.

FIG. 6 shows a diagram of the controller of the subsea wellhead fatigue damage evaluation systems of FIGS. 2 and 3 according to certain example embodiments.

FIG. 7 shows a computing device in accordance with certain example embodiments.

FIG. 8 shows a graph illustrating evaluating a subsea wellhead according to certain example embodiments.

FIG. 9 shows a graph illustrating measured fatigue damage to a subsea wellhead relative to the graph of FIG. 8 valves according to certain example embodiments.

FIG. 10 shows a flowchart of a method for evaluating subsea wellheads according to certain example embodiments.

### DETAILED DESCRIPTION

The example embodiments discussed herein are directed to systems, apparatus, methods, and devices for remotely evaluating subsea wellheads. Example embodiments may be used during certain types of field operations (e.g., drilling) in which subsea wellheads are used and regardless of which industry (e.g., oil, gas, water) applies. Example embodiments may be used in any depth (e.g., 100 feet, 1000 feet, 5000 feet, 10000 feet) of water in which a subsea wellhead is located and/or any distance (e.g., 1 foot, 10 feet, 50 feet) above the seabed floor that a subsea wellhead is located.

The use of the terms “about”, “approximately”, and similar terms applies to all numeric values, whether or not explicitly indicated. These terms generally refer to a range of numbers that one of ordinary skill in the art would consider as a reasonable amount of deviation to the recited numeric values (i.e., having the equivalent function or result). For example, this term may be construed as including a deviation of ±10 percent of the given numeric value provided such a deviation does not alter the end function or result of the value. Therefore, a value of about 1% may be construed to be a range from 0.9% to 1.1%. Furthermore, a range may be construed to include the start and the end of the range. For example, a range of 10% to 20% (i.e., range of 10%-20%) includes 10% and also includes 20%, and includes percentages in between 10% and 20%, unless explicitly stated otherwise herein. Similarly, a range of between 10% and 20% (i.e., range between 10%-20%) includes 10% and also includes 20%, and includes percentages in between 10% and 20%, unless explicitly stated otherwise herein.

A “subterranean formation” refers to practically any volume under a surface. For example, it may be practically any volume under a terrestrial surface (e.g., a land surface), practically any volume under a seafloor, etc. Each subsurface volume of interest may have a variety of characteristics, such as petrophysical rock properties, reservoir fluid properties, reservoir conditions, hydrocarbon properties, or any combination thereof. For example, each subsurface volume of interest may be associated with one or more of: temperature, porosity, salinity, permeability, water composition, mineralogy, hydrocarbon type, hydrocarbon quantity, reservoir location, pressure, etc. Those of ordinary skill in the art will appreciate that the characteristics are many, including, but not limited to, shale gas, shale oil, tight gas, tight oil, tight carbonate, carbonate, vuggy carbonate, unconventional (e.g., a permeability of less than 25 millidarcy (mD) such as a permeability of from 0.000001 mD to 25 mD)), diatomite, geothermal, mineral, etc. The terms “formation”, “subsurface formation”, “hydrocarbon-bearing formation”, “reservoir”, “subsurface reservoir”, “subsurface area of interest”, “subsurface region of interest”, “subsurface volume of interest”, and the like may be used synonymously. The term “subterranean formation” is not limited to any description or configuration described herein.

A “well” or a “wellbore” refers to a single hole, usually cylindrical, that is drilled into a subsurface volume of interest. A well or a wellbore may be drilled in one or more directions. For example, a well or a wellbore may include a vertical well, a horizontal well, a deviated well, and/or other type of well. A well or a wellbore may be drilled in the subterranean formation for exploration and/or recovery of resources. A plurality of wells (e.g., tens to hundreds of wells) or a plurality of wellbores are often used in a field depending on the desired outcome.

A well or a wellbore may be drilled into a subsurface volume of interest using practically any drilling technique and equipment known in the art, such as geosteering, directional drilling, etc. Drilling the well may include using a tool, such as a drilling tool that includes a drill bit and a drill string. Drilling fluid, such as drilling mud, may be used while drilling in order to cool the drill tool and remove cuttings. Other tools may also be used while drilling or after drilling, such as measurement-while-drilling (MWD) tools, seismic-while-drilling tools, wireline tools, logging-while-drilling (LWD) tools, or other downhole tools. After drilling to a predetermined depth, the drill string and the drill bit may be removed, and then the casing, the tubing, and/or other equipment may be installed according to the design of the well. The equipment to be used in drilling the well may be dependent on the design of the well, the subterranean formation, the hydrocarbons, and/or other factors.

A well may include a plurality of components, such as, but not limited to, a casing, a liner, a tubing string, a sensor, a packer, a screen, a gravel pack, artificial lift equipment (e.g., an electric submersible pump (ESP)), and/or other components. If a well is drilled offshore, the well may include one or more of the previous components plus other offshore components, such as a riser. A well may also include equipment to control fluid flow into the well, control fluid flow out of the well, or any combination thereof. For example, a well may include a wellhead, a choke, a valve, and/or other control devices. These control devices may be located on the surface, in the subsurface (e.g., downhole in the well), or any combination thereof. In some embodiments, the same control devices may be used to control fluid flow into and out of the well. In some embodiments, different control devices may be used to control fluid flow into and out of a well. In some embodiments, the rate of flow of fluids through the well may depend on the fluid handling capacities of the surface facility that is in fluidic communication with the well. The equipment to be used in controlling fluid flow into and out of a well may be dependent on the well, the subsurface region, the surface facility, and/or other factors. Moreover, sand control equipment and/or sand monitoring equipment may also be installed (e.g., downhole and/or on the surface). A well may also include any completion hardware that is not discussed separately. The term “well” may be used synonymously with the terms “borehole,” “wellbore,” or “well bore.” The term “well” is not limited to any description or configuration described herein.

It is understood that when combinations, subsets, groups, etc. of elements are disclosed (e.g., combinations of components in a composition, or combinations of steps in a method), that while specific reference of each of the various individual and collective combinations and permutations of these elements may not be explicitly disclosed, each is specifically contemplated and described herein. By way of example, if an item is described herein as including a component of type A, a component of type B, a component of type C, or any combination thereof, it is understood that this phrase describes all of the various individual and collective combinations and permutations of these components. For example, in some embodiments, the item described by this phrase could include only a component of type A. In some embodiments, the item described by this phrase could include only a component of type B. In some embodiments, the item described by this phrase could include only a component of type C. In some embodiments, the item described by this phrase could include a component of type A and a component of type B. In some embodiments, the item described by this phrase could include a component of type A and a component of type C. In some embodiments, the item described by this phrase could include a component of type B and a component of type C. In some embodiments, the item described by this phrase could include a component of type A, a component of type B, and a component of type C. In some embodiments, the item described by this phrase could include two or more components of type A (e.g., A1 and A2). In some embodiments, the item described by this phrase could include two or more components of type B (e.g., B1 and B2). In some embodiments, the item described by this phrase could include two or more components of type C (e.g., C1 and C2). In some embodiments, the item described by this phrase could include two or more of a first component (e.g., two or more components of type A (A1 and A2)), optionally one or more of a second component (e.g., optionally one or more components of type B), and optionally one or more of a third component (e.g., optionally one or more components of type C). In some embodiments, the item described by this phrase could include two or more of a first component (e.g., two or more components of type B (B1 and B2)), optionally one or more of a second component (e.g., optionally one or more components of type A), and optionally one or more of a third component (e.g., optionally one or more components of type C). In some embodiments, the item described by this phrase could include two or more of a first component (e.g., two or more components of type C (C1 and C2)), optionally one or more of a second component (e.g., optionally one or more components of type A), and optionally one or more of a third component (e.g., optionally one or more components of type B).

If a component of a figure is described but not expressly shown or labeled in that figure, the label used for a corresponding component in another figure may be inferred to that component. Conversely, if a component in a figure is labeled but not described, the description for such component may be substantially the same as the description for the corresponding component in another figure. The numbering scheme for the various components in the figures herein is such that each component is a three-digit number or a four-digit number, and corresponding components in other figures have the identical last two digits. For any figure shown and described herein, one or more of the components may be omitted, added, repeated, and/or substituted. Accordingly, embodiments shown in a particular figure should not be considered limited to the specific arrangements of components shown in such figure.

Further, a statement that a particular embodiment (e.g., as shown in a figure herein) does not have a particular feature or component does not mean, unless expressly stated, that such embodiment is not capable of having such feature or component. For example, for purposes of present or future claims herein, a feature or component that is described as not being included in an example embodiment shown in one or more particular drawings is capable of being included in one or more claims that correspond to such one or more particular drawings herein.

Example embodiments of remotely evaluating subsea wellheads will be described more fully hereinafter with reference to the accompanying drawings, in which example embodiments of remotely evaluating subsea wellheads are shown. Remotely evaluating subsea wellheads may, however, be embodied in many different forms and should not be construed as limited to the example embodiments set forth herein. Rather, these example embodiments are provided so that this disclosure will be thorough and complete, and will fully convey the scope of remotely evaluating subsea wellheads to those of ordinary skill in the art. Like, but not necessarily the same, elements (also sometimes called components) in the various figures are denoted by like reference numerals for consistency.

Terms such as “first”, “second”, “primary,” “secondary,” “above”, “below”, “inner”, “outer”, “distal”, “proximal”, “end”, “top”, “bottom”, “upper”, “lower”, “side”, “left”, “right”, “front”, “rear”, and “within”, when present, are used merely to distinguish one component (or part of a component or state of a component) from another. This list of terms is not exclusive. Such terms are not meant to denote a preference or a particular orientation, and they are not meant to limit embodiments of remotely evaluating subsea wellheads. In the following detailed description of the example embodiments, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

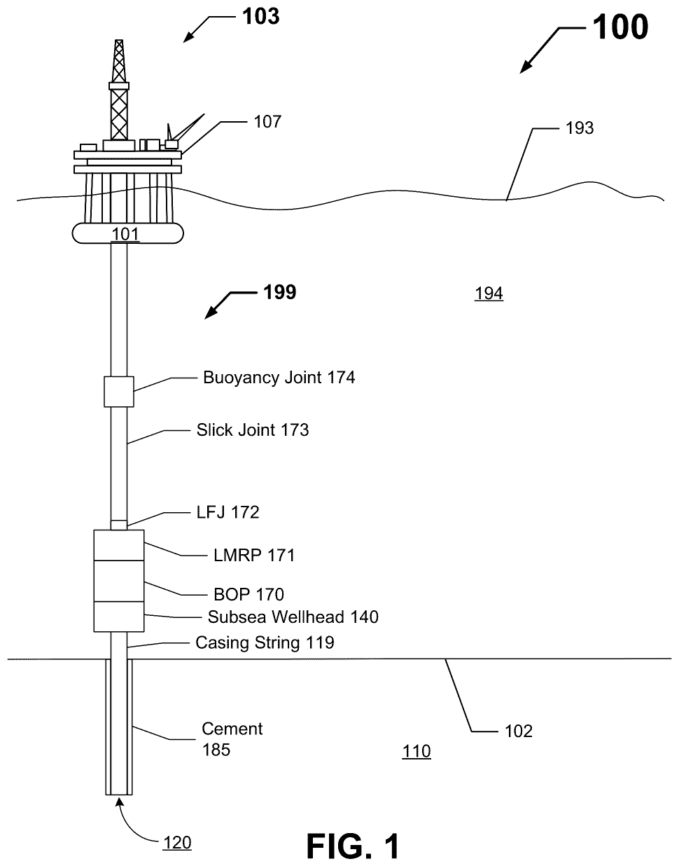

FIG. 1 shows a subsea field system 100 in which example embodiments may be used. The system 100 in this case includes a floating structure 103 in the form of a semi-submersible platform that floats in a large and deep body of water 194. In alternative embodiments, the structure 103 is not floating, but instead is a type of rig (e.g., a jack-up rig) that has one or more legs that rest on the seabed 102 (also sometimes called the subsea floor herein). In this example, part (e.g., the topsides 107) of the floating structure 103 is above the water line 193, and at least part (e.g., part of the hull 101) of the rest of the floating structure 103 is in the water 194 below the water line 193. The floating structure 103 in this case is used for subterranean field operations (also called subsea field operations herein), in which well construction (e.g., drilling) and production phases (also called stages) of the subsea field operation are executed to drill a wellbore 120 and subsequently extract one or more subterranean resources (e.g., oil, natural gas, water, hydrogen gas) from and/or inject resources (e.g., carbon monoxide, carbon dioxide, water) into the subterranean formation 110 via the wellbore 120. In some cases, a field operation involves multiple wellbores 120 that originate from the same proximate location (sometimes called a pad) on the seabed 102. In such cases, the wellbores 120 are drilled one at a time. The system 100 can, in alternative embodiments, include additional and/or alternative features and/or components, depending on the objective of the field operation.

During field operations (e.g., drilling), multiple pieces of equipment are used in the water 194 above the seabed 102. For example, in this case, such pieces of equipment may include a buoyancy joint 174, a slick joint 173, a lower flex joint (LFJ) 172, a lower marine rising package (LMRP) 171, a blowout preventer (BOP) 170, a subsea wellhead 140, and a casing string 119. All of these components may be collectively referred to herein as a subsea assembly 199. These components of the subsea assembly 199 are coupled to each other in series. Other pieces of equipment (e.g., a riser, mooring lines) that are common for the subsea assembly 199 of the subsea field system 100 may be omitted from FIG. 1 to simplify the drawing.

The subsea wellhead 140 may include one or more of a number of different components. Examples of such components may include, but are not limited to, a high pressure housing, a low pressure housing, a supplemental adapter joint, a heavy wall extension, one or more casing hangers, seals and a lockdown sub. Extending below the wellhead 140 and into the wellbore 120 within the subterranean formation 110 is a casing string 119. The casing string 119 is held to the wall of the subterranean formation 110 around the wellbore 120 by cement 185. In some alternative cases, no cement 185 is used between the casing string 119 and the subterranean formation 110. The upper part of the casing string 119, between the subsea wellhead 140 and the seabed 102, may be exposed in the water 194. In some cases, there may be multiple casing strings 119 concentrically arranged and each hanging from the subsea wellhead 140 to extend into the wellbore 120.

The subsea wellhead 140 can be subjected to tremendous cyclic stresses over time. These cyclic stresses may cause permanent fatigue damage in the subsea wellhead 140. If the subsea wellhead 140 fails as a result of this fatigue damage, unsafe conditions may arise, causing a potential loss of life, equipment, and/or other resources. The subsea wellhead 140 is subjected to cyclic stresses due to one or more factors. For example, the one or more casing strings 119 that hang from the subsea wellhead 140 into the wellbore 120 are cemented to the subterranean formation 110, and so any force (e.g., currents in the water 194 at or near the seabed 102) that push against the subsea wellhead 140 applies a stress to the subsea wellhead 140 that may result in permanent fatigue damage.

As another example, the floating structure 103 is not stationary. In turbulent environments at or near the water line 193, the floating structure 103 can have relatively extreme movements. While some of the equipment (e.g., the buoyance joint 174, the LFJ 172) is designed to absorb much of the impact of these stresses that originate from the vicinity of the water line 193, some of these forces may still pass on to the subsea wellhead 140.

In the current art, different methods are used to determine fatigue damage of subsea wellheads with limited success. For example, using motion sensor that are installed on the BOP 170 and/or strain gauges that are installed on the subsea wellhead 140 can be expensive and involve rig loss time for device deployment and retrieval. Due to the harsh environment and operating conditions, these sensors and gauges can be subject to occasional failure over a long (e.g., 5 years, 10 years) period of time. Example embodiments can reliably provide measurements that lead to fatigue damage monitoring and evaluation of subsea wellheads over long periods of time without the need for sensors, gauges, and/or other devices installed on the equipment at or near the subsea wellhead 140.

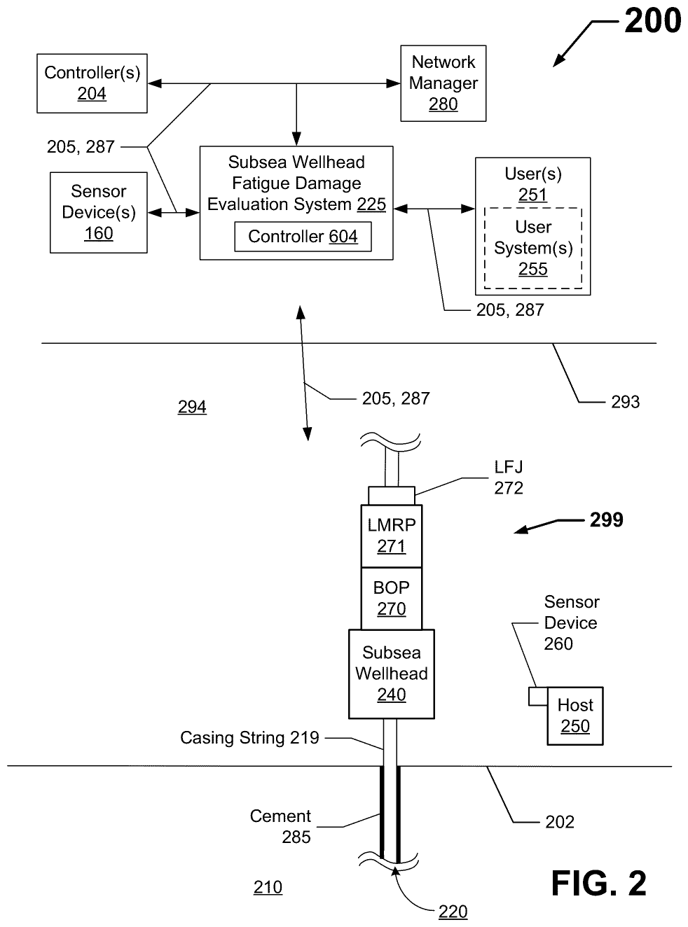

FIG. 2 shows a block diagram of a system 200 for remotely evaluating a subsea wellhead 240 according to certain example embodiments. Referring to FIGS. 1 and 2, the system 200 of FIG. 2 includes a subsea well 220, a subsea assembly 299 that includes a LFJ 272, a LMRP 271, a BOP 270, and a subsea wellhead 240, one or more casing strings 219, cement 285, one or more controllers 204, one or more sensor devices 160, one or more users 251 (including one or more optional user systems 255), a network manager 280, an example subsea wellhead fatigue damage evaluation system 225, one or more sensor devices 260, one or more hosts 250, one or more communication links 205, and one or more power transfer links 287.

The LFJ 272, the LMRP 271, the BOP 270, the subsea wellhead 240, and the top end of the one or more casing strings 219 are located in the water 294 near the seabed 202. The cement 285 secures most of the casing string 219 to the subterranean formation 210 in the wellbore 220. The LFJ 272, the LMRP 271, the BOP 270, the subsea wellhead 240, the casing strings 219, and the cement 285 may be substantially the same as the LFJ 172, the LMRP 171, the BOP 170, the subsea wellhead 140, the casing strings 119, and the cement 185 discussed above with respect to FIG. 1.

The components shown in FIG. 2 are not exhaustive, and in some embodiments, one or more of the components shown in FIG. 2 may not be included in the example system 200. Any component of the system 200 may be discrete or combined with one or more other components of the system 200. Also, one or more components of the system 200 may have different configurations. For example, the host 250 and/or one or more sensor devices 260 may be disposed above the water line 293 rather than all being submerged in the water 294. As another example, a controller 204, rather than being a stand-alone device, may be part of one or more other components (e.g., a ROV, the subsea wellhead fatigue damage evaluation system 225) of the system 200.

In some cases, the users 251 (including the associated user systems 255), the controllers 204, parts of the subsea wellhead fatigue damage evaluation system 225, and the network manager 280 may be located on the topsides (e.g., topsides 107) of a floating structure (e.g., floating structure 103), a non-floating structure in the water 294, or a land-based structure. In addition, or in the alternative, one or more users 251 (including any associated user system 255), one or more controllers 204, parts of the subsea wellhead fatigue damage evaluation system 225, and/or the network manager 280 may be located elsewhere (e.g., in an office building on land, in the water 294).

A user 251 may be any person that interacts, directly or indirectly, with the example subsea wellhead fatigue damage evaluation system 225 and/or any other component of the system 200. Examples of a user 251 may include, but are not limited to, a business owner, an engineer, a company representative, a geologist, a consultant, a contractor, and a manufacturer's representative. A user 251 may use one or more user systems 255, which may include a display (e.g., a GUI). A user system 255 of a user 251 may interact with (e.g., send data to, obtain data from) the subsea wellhead fatigue damage evaluation system 225, a controller 204, the network manager 280, and/or any other component of the system 200 via an application interface and using the communication links 205 (discussed below). The user 251 may also interact directly with the subsea wellhead fatigue damage evaluation system 225, a controller 204, the network manager 280, and/or any other component of the system 200 through a user interface (e.g., keyboard, mouse, touchscreen).

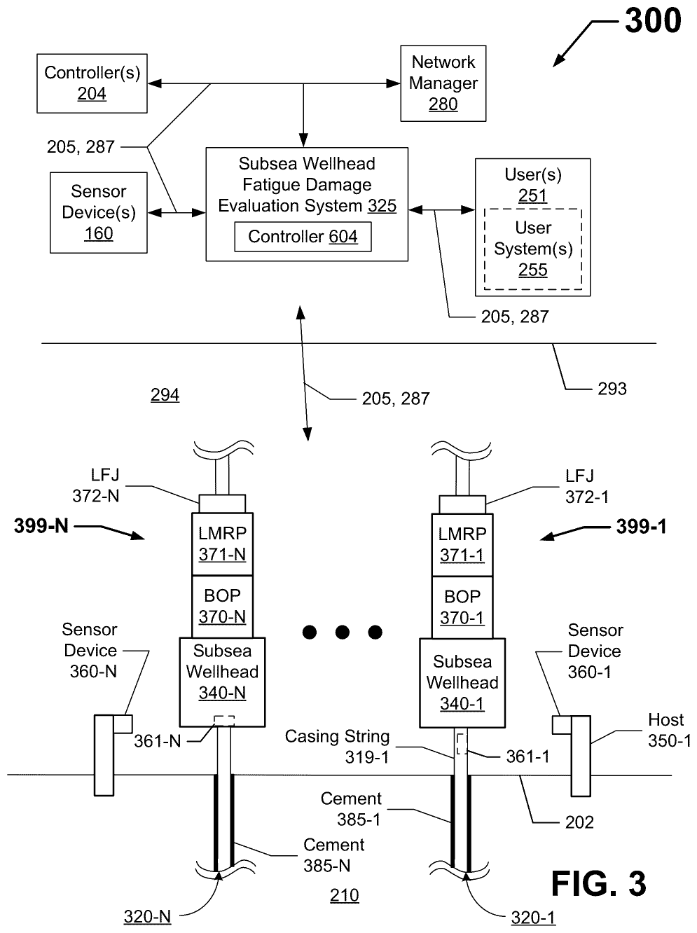

A user system 255 of a user 251 interacts with (e.g., sends data to, receives data from) the subsea wellhead fatigue damage evaluation system 225 via an application interface (discussed below with respect to FIG. 3). Examples of a user system 255 may include, but are not limited to, a cell phone with an app, a laptop computer, a handheld device, a smart watch, a desktop computer, and an electronic tablet. In some cases, a user 251 (including an associated user system 255) may also interact directly with the network manager 280, one or more of the controllers 204, one or more hosts 250, one or more of the sensor devices 160, and/or one or more of the sensor devices 260 in the system 200 using one or more communication links 205.

The network manager 280 is a device or component that controls all or a portion (e.g., a communication network, a controller 204, the subsea wellhead fatigue damage evaluation system 225) of the system 200. The network manager 280 may be substantially similar to the controller 604 of the subsea wellhead fatigue damage evaluation system 225, discussed below. For example, the network manager 280 may include a controller that has one or more components and/or similar functionality to some or all of the controller 604. Alternatively, the network manager 280 may include one or more of a number of features in addition to, or altered from, the features of the controller 604. As described herein, control and/or communication with the network manager 280 may include communicating with one or more other components of the same system 200 or another system. In such a case, the network manager 280 may facilitate such control and/or communication. The network manager 280 may be called by other names, including but not limited to a master controller, a network controller, and an enterprise manager. The network manager 280 may be considered a type of computer device, as discussed below with respect to FIG. 7.

As mentioned above, the system 200 may include one or more controllers 204. Each controller 204 may be communicably coupled to the subsea wellhead fatigue damage evaluation system 225. A controller 204 may also be communicably coupled to one or more other components of the system 200, including but not limited to the network manager 280, a user 251 (including an associated user system 255), and one or more sensor devices 160. A controller 204 performs a number of functions that include obtaining and sending data, evaluating data, following protocols, running algorithms, and sending commands. A controller 204 may include one or more of a number of components.

A controller 204 of FIG. 2 may include one or more of the components of the controller 604 (discussed below with respect to FIG. 5) of the subsea wellhead fatigue damage evaluation system 225 and/or perform one or more of the functions of the controller 604 of the subsea wellhead fatigue damage evaluation system 225. For example, components of a controller 204 may include, but are not limited to, a control engine, a communication module, a timer, a counter, a power module, a storage repository, a hardware processor, memory, a transceiver, an application interface, and a security module.

When there are multiple controllers 204 (e.g., one controller 204 valves in the subsea wellhead 240, another controller 204 for a system on the topsides 107), each controller 204 may operate independently of each other. Alternatively, one or more of the controllers 204 may work cooperatively with each other. As yet another alternative, one of the controllers 204 may control some or all of one or more other controllers 204 in the system 200. As still another alternative, each controller 204 may be in communication with and controlled by the controller 604 of the subsea wellhead fatigue damage evaluation system 225. Each controller 204 may be considered a type of computer device, as discussed below with respect to FIG. 7.

Each sensor device 160 includes one or more sensors that measure one or more parameters (e.g., pressure, flow rate, temperature, humidity, fluid content, voltage, current, presence of an object or component, chemical elements in a fluid). Examples of a sensor of a sensor device 160 may include, but are not limited to, a temperature sensor, a flow sensor, a pressure sensor, a proximity sensor, a gas spectrometer, a voltmeter, an ammeter, a permeability meter, a porosimeter, and a camera. A sensor device 160 may be integrated with or measure a parameter associated with one or more components of the system 200. For example, a sensor device 160 may be configured to measure a parameter (e.g., flow rate, pressure, temperature) of drilling mud used during a drilling operation.

In certain example embodiments, a sensor device 160 can be a type of sensor device (e.g., motion sensors, strain gauges) used in the current art for evaluating a subsea wellhead. In some cases, a number of sensor devices 160, each measuring a different parameter, may be used in combination to determine and confirm whether a controller 204 should take a particular action (e.g., operate a valve, operate or adjust the operation of a pump, send a notification). When a sensor device 160 includes its own controller (e.g., a controller 204), or portions thereof, then the sensor device 160 may be considered a type of computer device, as discussed below with respect to FIG. 7.

As discussed below with respect to FIG. 5, the subsea wellhead fatigue damage evaluation system 225 may include multiple components. For example, in certain example embodiments, the subsea wellhead fatigue damage evaluation system 225 may include a controller 604 (discussed below), one or more valves, one or more sensor devices (e.g., sensor devices 260), one or more hosts 250, and/or other equipment that may be used, for example, to remotely evaluate the subsea wellhead 240. The subsea wellhead fatigue damage evaluation system 225 in this example is directly communicably coupled to the one or more controllers 204, the one or more users 251 (including associated user systems 255), the network manager 280, one or more hosts 250, and one or more sensor devices 260.

In this example, a portion (e.g., the controller 604) of the example subsea wellhead fatigue damage evaluation system 225 is located above the water line 293 (e.g., on the topsides 107 of the floating structure 103). The subsea wellhead fatigue damage evaluation system 225 is configured to use real time data, captured over time, to reliably determine whether the subsea wellhead 240 is failing due to stresses and fatigue damage. In alternative embodiments, a portion of the example subsea wellhead fatigue damage evaluation system 225 may be located at some other location (e.g., on an adjacent floating structure, in an office building on land, in a trailer on land at a production complex, with the host 250). In some cases, the example subsea wellhead fatigue damage evaluation system 225 may be distributed among multiple locations (e.g., part of the example subsea wellhead fatigue damage evaluation system 225 is located on the topsides 107 of the floating structure 103, another part of the subsea wellhead fatigue damage evaluation system 225 is located in an office building, and yet another part of the subsea wellhead fatigue damage evaluation system 225 is integrated with the host 250).

The host 250 may be considered part of the subsea wellhead fatigue damage evaluation system 225. The host 250 is configured to have one or more sensor devices 260 disposed thereon. The host 250 is also configured to position each sensor device 260 within a line of sight to the subsea wellhead 240 and/or the casing string 219 positioned between the subsea wellhead 240 and the seabed 202. The host 250 allows a sensor device 260 to measure one or more parameters associated with the subsea wellhead 240 without physically contacting the subsea wellhead 240 or any other part of the subsea assembly 299. In this way, factors that cause the failure of sensor devices currently used in the art to determine fatigue damage of the subsea wellhead are avoided. The host 250 (and so also any sensor devices 260 coupled to the host 250) is configured to be positioned separately from and adjacent to the subsea wellhead 240. Put another way, the host 250 (and so also any sensor devices 260 coupled to the host 250) avoid making direct contact with the subea wellhead 240 and/or any other parts of the subsea assembly 299. In this way, the evaluation of the subsea wellhead 240 using example embodiments is remote.

The host 250 may take on any of a number of forms. For example, in this case, the host 250 of FIG. 2 is in the form of a remotely operated vehicle (ROV), which is configured to be dispatched into the water 294 on occasion to perform an inspection of one or more components (e.g., the subsea assembly 299, mooring lines, the hull 101) of the system 200 or one or more aspects (e.g., the seabed 202) associated with the system 200. The host 250 in this case may be autonomous (e.g., operates based on instructions or an objective) or controlled remotely, via communication links 205, by a person (e.g., on the topsides 107 of a floating structure 103) using a control device. In some cases, a host 250 may include an energy storage device (e.g., a battery) and/or some other source of power that is in addition to or an alternative of the power that may flow through the power transfer links 287.

Each sensor device 260 that is coupled to, integrated with, or otherwise part of a host 250 may be considered part of the subsea wellhead fatigue damage evaluation system 225. Each sensor device 260 may be substantially the same as a sensor device 160 discussed above, except that the one or more parameters measured by a sensor device 260 are associated with stresses on and fatigue damage of the subsea wellhead 240. Examples of such parameters may include, but are not limited to, vibrations, movement, subsea current, metocean data, temperature, and pressure. Examples of a sensor for a sensor device 260 may include, but are not limited to, a camera, a thermometer, an accelerometer, a pressure gauge, a flow meter, and an infrared transceiver. Some sensors of a sensor device 260 may only be suitable for certain configurations of a host 250. For example, when the host 250 is a ROV and non-contact measurements associated with the subsea wellhead 240 are involved, then sensors such as an accelerometer, a pressure gauge, and/or a flow meter may not be used.

In this case, the sensor device 260 may be or include a high-definition camera mounted to the host 250 in the form of a ROV. The camera is directed to and captures images (e.g., still images, video footage) of the subsea wellhead 240 and/or the casing string 219 positioned between the subsea wellhead 240 and the seabed 202. In certain example embodiments, the host 250 and/or the sensor device 260 may include one or more light sources to provide illumination when the camera captures the images at or near the seabed 202. In some cases, the subsea wellhead 240 and/or the casing string 219 positioned between the subsea wellhead 240 and the seabed 202 may have disposed thereon one or more markers (e.g., etchings, stickers, plates, different color paint) that can be included in the images captured by the sensor device 260.

The images captured by the sensor device 260 in this case may be provided (e.g., using communication links 205) to the controller 604 of the subsea wellhead fatigue damage evaluation system 225. In such a case, the controller 604 of the subsea wellhead fatigue damage evaluation system 225 may analyze the images (e.g., using digital correlation methods, using computer vision algorithms) to extract the vibration signature of the subsea wellhead 240. In such a case, the controller 604 of the subsea wellhead fatigue damage evaluation system 225 may identify and determine (e.g., calculate) hot spot stresses, which may lead to the determination (e.g., calculation) of the fatigue damage rate, the accumulated damage, and/or other considerations associated with the subsea wellhead 240.

When the host 250 is in the form of a ROV, as in this example, the one or more sensor devices 260 used to evaluate the subsea wellhead 240 do not need to be permanently coupled to or integrated with the ROV. Instead, the one or more sensor devices 260 may be coupled to the ROV on an as-needed basis without undue time or expense. Capturing images (or otherwise measuring parameters associated with the subsea wellhead 240 and/or the casing string 219 positioned between the subsea wellhead 240 and the seabed 202) by a sensor device 260 may be done on a continuous basis, randomly, when current near the seabed 202 exceeds a threshold value (e.g., 1 knot), on fixed time intervals (e.g., every 6 hours, every 24 hours, every hour), and/or on some other basis.

For example, in this case, the host 250 in the form of a ROV may only be put into the water 294 and sent to the seabed 202 to capture images using the sensor device 260 when the current near the seabed 202 exceeds 1 knot, which may coincide with when the metocean conditions become more extreme and fatigue damage of the subsea wellhead 240 may be a concern. This approach may be pursued because the fatigue damage rate from benign metocean conditions may be relatively small and may be estimated by using physics-based modeling or data-based modeling.

The system 200 may include multiple wellbores 220 and multiple subsea assemblies 299. In this case, there is only one wellbore 220 and one subsea assembly 299. Each subsea assembly 299 may include a subsea wellhead 240. In this example, there is only one wellbore 220 and one subsea assembly 299. In alternative embodiments, there can be multiple wellbores 220, each with its own subsea assembly 299 (including a subsea wellhead 240).

Communication between the network manager 280, the users 251 (including any associated user systems 255), the controllers 204, the sensor devices 160, the subsea wellhead fatigue damage evaluation system 225 (including portions thereof, such as a sensor device 260 and a host 250), and any other components of the system 200 may be facilitated using the communication links 205. Each communication link 205 may include wired (e.g., Class 1 electrical cables, electrical connectors, Power Line Carrier, RS485) and/or wireless (e.g., sound or pressure waves in the water 194, Wi-Fi, Zigbee, visible light communication, cellular networking, Bluetooth, Bluetooth Low Energy (BLE), ultrawide band (UWB), WirelessHART, ISA100) technology.

Similarly, the transfer of power between any two components (e.g., a host 250 and a sensor device 260, a sensor device 160 and the subsea wellhead fatigue damage evaluation system 225, a host and the subsea wellhead fatigue damage evaluation system 225) may be facilitated using power transfer links 287. Each power transfer link 287 may include one or more electrical conductors, which may be individual or part of one or more electrical cables. In some cases, as with inductive power, power may be transferred wirelessly using power transfer links 287. A power transfer link 287 may transmit power from one component of the system 200 to another. Each power transfer link 287 may be sized (e.g., 12 gauge, 18 gauge, 4 gauge) in a manner suitable for the amount (e.g., 480V, 24V, 120V) and type (e.g., alternating current, direct current) of power transferred therethrough.

FIG. 3 shows a block diagram of another system 300 for remotely evaluating subsea wellheads according to certain example embodiments. The system 300 of FIG. 3 includes multiple subsea wells 320 (subsea well 320-1 through subsea well 320-N) and multiple subsea assemblies 399 (subsea assembly 399-1 through subsea assembly 399-N), where each subsea assembly 399 includes a LFJ 372 (LFJ 372-1 thorough LFJ 372-N), a LMRP 371 (LMRP 371-1 through LMRP 371-N), a BOP 370 (BOP 370-1 through BOP 370-N), a subsea wellhead 340 (subsea wellhead 340-1 through subsea wellhead 340-N), a casing string 319 (casing string 319-1 through casing string 319-N), and cement 385 (cement 385-1 through cement 385-N). The system 300 in this case also includes one or more controllers 204, one or more sensor devices 160, one or more users 251 (including one or more optional user systems 255), a network manager 280, one or more communication links 205, and one or more power transfer links 287.

The LFJs 372, the LMRPs 371, the BOPs 370, the subsea wellheads 340, and the top end of the casing strings 319 are located in the water 294 near the seabed 202. The cement 385 secures most of the casing string 319 to the subterranean formation 210 in each wellbore 320. The LFJs 372, the LMRPs 371, the BOPs 370, the subsea wellheads 340, the casing strings 319, and the cement 385 may be substantially the same as the LFJs, the LMRPs, the BOPs, the subsea wellheads8, and the casing strings, and the cement 185 discussed above with respect to FIGS. 1 and 2. Similarly, the controllers 204, sensor devices 160, the users 251 (including the corresponding user systems 255), the network manager 280, the communication links 205, and the power transfer links 287 are the same as in FIG. 2 above.

The components shown in FIG. 3 are not exhaustive, and in some embodiments, one or more of the components shown in FIG. 3 may not be included in the example system 300. Any component of the system 300 may be discrete or combined with one or more other components of the system 300. Also, one or more components of the system 300 may have different configurations.

Referring to FIGS. 1 through 3, the subsea wellhead fatigue damage evaluation system 325 is substantially the same as in FIG. 2, except as described below. For example, in certain example embodiments, the subsea wellhead fatigue damage evaluation system 325 may include the controller 604, one or more valves, multiple sensor devices (e.g., sensor device 360-1 through sensor device 360-N), multiple hosts 350 (e.g., (host 350-1 through host 350-N), and/or other equipment that may be used, for example, to remotely evaluate the subsea wellheads 340. The subsea wellhead fatigue damage evaluation system 325 in this example is directly communicably coupled to the one or more controllers 204, the one or more users 251 (including associated user systems 255), the network manager 280, the hosts 350, and the sensor devices 360.

In this example, a portion (e.g., the controller 604 or portions thereof) of the example subsea wellhead fatigue damage evaluation system 325 is located above the water line 293 (e.g., on the topsides 107 of the floating structure 103). The subsea wellhead fatigue damage evaluation system 325 is configured to use real time data, captured over time, to reliably determine whether each of the subsea wellheads 340 is failing due to stresses and fatigue damage. In alternative embodiments, a portion of the example subsea wellhead fatigue damage evaluation system 325 may be located at some other location (e.g., on an adjacent floating structure, in an office building on land, in a trailer on land at a production complex, with one or more of the hosts 350). In some cases, the example subsea wellhead fatigue damage evaluation system 325 may be distributed among multiple locations (e.g., part of the example subsea wellhead fatigue damage evaluation system 325 is located on the topsides 107 of the floating structure 103, another part of the subsea wellhead fatigue damage evaluation system 325 is located in an office building, and yet another part of the subsea wellhead fatigue damage evaluation system 325 is integrated with the hosts 350).

Each of the hosts 350 and each of the sensor devices 360 may be substantially the same as the host 250 and the sensor device 260 discussed above with respect to FIG. 2. For example, each host 350 of the subsea wellhead fatigue damage evaluation system 325 is configured to have one or more of the sensor devices 360 disposed thereon. As another example, each host 350 (and so also any sensor devices 360 coupled to the host 350) is configured to be positioned separately from and adjacent to the subsea wellhead 340. Put another way, each host 350 (and so also any sensor devices 360 coupled to each host 350) avoid making direct contact with a subea wellhead 340 and/or any other parts of a subsea assembly 399. In this way, the evaluation of each subsea wellhead 340 using example embodiments is remote. Each host 350 may also be configured to position each sensor device 360 within a line of sight to one of the subsea wellheads 340 and/or one of the casing strings 319 positioned between the associated subsea wellhead 340 and the seabed 202. Each host 350 allows one or more of the sensor devices 360 to measure one or more parameters associated with a subsea wellhead 340 without physically contacting the subsea wellhead 340 or any other part of a subsea assembly 399. In this way, factors that cause the failure of sensor devices currently used in the art to determine fatigue damage of the subsea wellhead are avoided.

As discussed above, each host 350 may take on any of a number of forms. For example, in this case, each host 350 of FIG. 3 is in the form of a stand that is embedded in the seabed 202. As a result, each host 350 in this case is fixed in place, although in some cases (e.g., in instances of high current in the water 294 near the seabed 202) parts (e.g., the upper portion) of each host 350 may flex or otherwise move for periods of time.

Each sensor device 360 that is coupled to, integrated with, or otherwise part of a host 350 may be considered part of the subsea wellhead fatigue damage evaluation system 325. Each sensor device 360 may be substantially the same as the sensor device 260 of FIG. 2. In this case, each sensor device 360 may be or include a transceiver that is capable of transmitting and receiving one or more signals (e.g., infrared signals, sonic signals). A sensor device 360 in this example is coupled (e.g., mounted) to a host 350 in the form of a stand or other type of structure mounted in the seabed 202. Examples of a sensor for a sensor device 360 may include, but are not limited to, a passive infrared sensor, a photocell, a pressure sensor, a proximity sensor, a SONAR sensor, a LIDAR sensor, a seismic sensor, a camera, a global positioning system, a gyroscope, a magnetometer, an accelerometer, and a fluid flow monitor.

The transmission part of the transceiver of a sensor device 360 in this example is configured to send a signal, and the receiver part of the transceiver of the sensor device 360 is configured to receive a reflection or return of that signal. In some cases, the subsea wellhead 340 and/or the casing string 319 positioned between the subsea wellhead 340 and the seabed 202 may have disposed thereon one or more markers 361 (e.g., etchings, stickers, plates, a natural marine deposit, a different material relative to the rest of the subsea wellhead 340 and/or the casing string 319 disposed in the water 294 above the seabed 202, paint of a different color) that can be included to reflect or otherwise provide a point of reference for the signal that is received by the receiver part of the transceiver of the sensor device 360. In this case, marker 361-1 is disposed on the outer surface of part of the casing string 319-1, and marker 361-N is disposed on the outer surface of part of the subsea wellhead 340-N.

A sensor device 360 may be configured to detect and/or measure a difference in one or more characteristics (e.g., wavelength, amplitude, frequency) between a signal that is sent by the transmitter and received by the receiver. These differences may be used as inputs to one or more algorithms (e.g., algorithms 633 discussed below) to determine a vibration signature of a subsea wellhead 340. The raw measurements and/or the differences may be provided (e.g., using communication links 205) by a sensor device 360 to the controller 604 of the subsea wellhead fatigue damage evaluation system 325.

In such a case, the controller 604 of the subsea wellhead fatigue damage evaluation system 325 may analyze the differences and/or measurements (e.g., using digital correlation methods, using simulation algorithms) to extract the vibration signature of a subsea wellhead 340. In such a case, the controller 604 of the subsea wellhead fatigue damage evaluation system 325 may identify and determine (e.g., calculate) hot spot stresses, which may lead to the determination (e.g., calculation) of the fatigue damage rate, the accumulated damage, and/or other considerations associated with each of the subsea wellheads 340.

When a host 350 is in the form of a structure embedded in the seabed 202, as in this example, the one or more sensor devices 360 used to evaluate each subsea wellhead 340 may be fixedly coupled to or integrated with the host 350. Alternatively, one or more of the sensor devices 360 may be coupled to (e.g., added, removed, replaced) the host 350 on an as-needed basis without undue time or expense. Receiving signals (or otherwise measuring parameters associated with a subsea wellhead 340 and/or the casing string 319 positioned between the subsea wellhead 340 and the seabed 202) by a sensor device 360 may be done on a continuous basis, randomly, when current near the seabed 202 exceeds a threshold value (e.g., 1 knot), on fixed time intervals (e.g., every 6 hours, every 24 hours, every hour), and/or on some other basis.

For example, the host 350 in the form of a structure embedded in the seabed 202 may include a sensor device that measures current near the seabed 202 in addition to the one or more sensor devices 360. In such a case, the sensor devices 360 may be configured to be dormant when the current measured by the sensor device is less than 1 knot, and may also be configured to send and receive signals every minute when the current is 1 knot or greater. This arrangement may coincide with when the metocean conditions become more extreme and fatigue damage of the subsea wellheads 340 may be a concern. This approach may be pursued because the fatigue damage rate from benign metocean conditions may be relatively small and may be estimated by using physics-based modeling or data-based modeling.

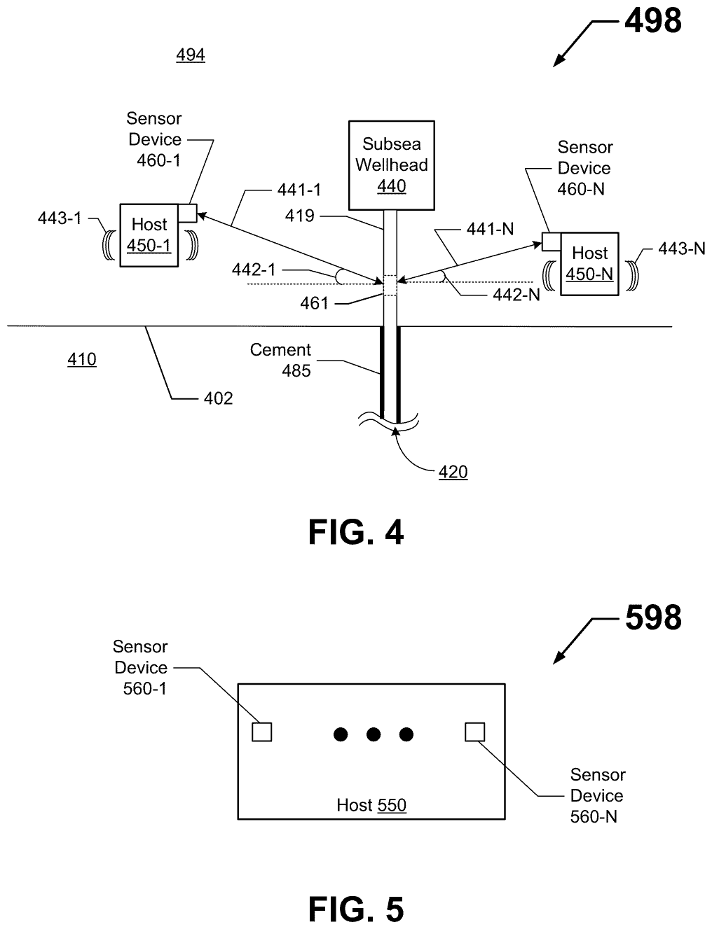

FIG. 4 shows a block diagram of a subsystem 498 for remotely evaluating a subsea wellhead 440 according to certain example embodiments. Referring to FIGS. 1 through 4, the subsystem 498 of FIG. 4 includes a subsea wellhead 440, multiple hosts 450 (host 450-1 through host 450-N), and multiple sensor devices 460 (sensor device 460-1 through sensor device 460-N), all of which are located in water 494. There is an optional marker 461 disposed on the outer surface of part of the casing string 419 between the subsea wellhead 440 and the seabed 402. Extending below the subsea wellhead 440 is a casing string 419 that extends through the seabed 402 into the wellbore 420. The casing string 419 is secured against the subterranean formation 410 by cement 485. The various components (e.g., the hosts 450, the sensor devices 460, the wellhead 440) of the subsystem 498 of FIG. 4 are substantially the same as the corresponding components discussed above with respect to FIGS. 1 through 3.

The sensor devices 460 and the hosts 450 may be part of an example subsea wellhead fatigue damage evaluation system (e.g., subsea wellhead fatigue damage evaluation system 225, subsea wellhead fatigue damage evaluation system 325). In this case, each host 450 has one sensor device 460. For example, host 450-1 includes sensor device 460-1, and host 450-N includes sensor device 460-N. In this example, the hosts 450 are in the form of ROVs. Also, each sensor device 460 is in the form of a camera. Regardless of the form of a sensor device 460 and/or the form of a host 450, it may be important to account for one or more environmental factors (e.g., distance, angle, turbulence) at the time that the sensor device 460 measures one or more parameters (e.g., captures an image, receives a signal).

For example, the distance 441 between a sensor device 460 and the portion of the subsea wellhead 440 and/or the casing string 419 being targeted by the sensor device 460 may have an impact on the output of one or more algorithms (e.g., algorithms 633) used by the controller (e.g., controller 604) of an example subsea wellhead fatigue damage evaluation system to determine the extent of fatigue damage with the subsea wellhead 440. In this case, sensor device 460-1 is a distance 441-1 from the marker 461 on the casing string 419 below the subsea wellhead 440. Also, sensor device 460-N is a distance 441-N from the marker 461 on the casing string 419 below the subsea wellhead 440. In certain example embodiments, the sensor devices 460 and/or a separate sensor device (e.g., sensor device 160) that is part of the host 450 may be configured to measure the distance 441.

As another example, the angle 442 between a sensor device 460 and the portion of the subsea wellhead 440 and/or the casing string 419 being targeted by the sensor device 460 may have an impact on the output of one or more algorithms (e.g., algorithms 633) used by the controller (e.g., controller 604) of an example subsea wellhead fatigue damage evaluation system to determine the extent of fatigue damage with the subsea wellhead 440. In this case, sensor device 460-1 is at an angle 442-1 relative to the marker 461 on the casing string 419 below the subsea wellhead 440. Also, sensor device 460-N is at an angle 442 relative to the marker 461 on the casing string 419 below the subsea wellhead 440. In certain example embodiments, the sensor devices 460 and/or a separate sensor device (e.g., sensor device 160) that is part of the host 450 may be configured to measure the angle 442.

As yet another example, the amount of turbulence 443 that is experienced by the combination of the sensor device 460 and the host 450 at the time that the sensor device 460 is measuring a parameter may have an impact on the output of one or more algorithms (e.g., algorithms 633) used by the controller (e.g., controller 604) of an example subsea wellhead fatigue damage evaluation system to determine the extent of fatigue damage with the subsea wellhead 440. In this case, host 450-1 (and so also sensor device 460-1) experiences turbulence 443-1 at the point in time captured in FIG. 4. Also, host 450-N(and so also sensor device 460-N) experiences turbulence 443-N at the point in time captured in FIG. 4. In certain example embodiments, the sensor devices 460 and/or a separate sensor device (e.g., sensor device 160) that is part of the host 450 may be configured to measure the turbulence 443.

FIG. 5 shows a front view of a subsystem 598 that includes a host 550 with multiple sensor devices 560 according to certain example embodiments. Referring to FIGS. 1 through 5, the subsystem 598 of FIG. 5 includes a single host 550 (e.g., in the form of a ROV, in the form of a structure embedded in the seabed (e.g., seabed 202). Disposed on the host 550 are multiple sensor devices 560 (sensor device 560-1 through sensor device 560-N). The one or more parameters measured by one of the sensor devices 560 may be the same as, or different than, the one or more parameters measured by one or more of the other sensor devices 560 coupled to the host 550. The hosts 550 and the sensor devices 560 of FIG. 5 are substantially the same as the hosts and sensor devices discussed above with respect to FIGS. 1 through 4.

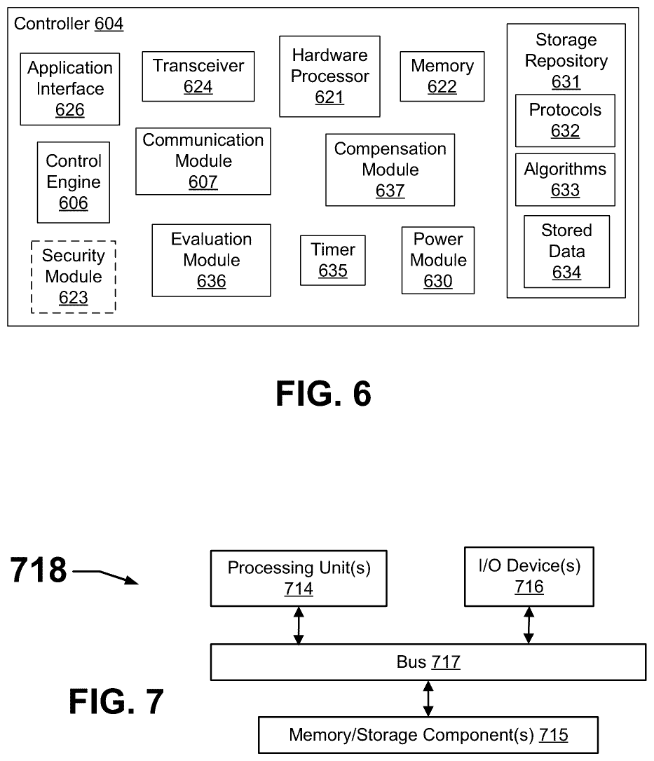

FIG. 6 shows a diagram of the controller 604 of the example subsea wellhead fatigue damage evaluation systems of FIGS. 2 and 3 according to certain example embodiments. Referring to FIGS. 1 through 6, the controller 604 may include multiple components. For example, in this case, the controller 604 may include a control engine 606, an evaluation module 636, a compensation module 637, a communication module 607, a timer 635, a power module 630, a storage repository 631, a hardware processor 621, a memory 622, a transceiver 624, an application interface 626, and, optionally, a security module 623. The various components of the controller 604 may be centrally located. In addition, or in the alternative, some of the components of the controller 604 may be located remotely from (e.g., in the cloud, at an office building) one or more of the other components of the controller 604.

The components shown in FIG. 6 are not exhaustive, and in some embodiments, one or more of the components shown in FIG. 6 may not be included in the example controller 604 of the subsea wellhead fatigue damage evaluation system (e.g., subsea wellhead fatigue damage evaluation system 225, subsea wellhead fatigue damage evaluation system 325). Any component of the controller 604 may be discrete or combined with one or more other components of the controller 604. Also, one or more components of the controller 604 may have different configurations. For example, the controller 604, rather than being a stand-alone device, may be part of one or more other components of the subsea wellhead fatigue damage evaluation system. For instance, part of the controller 604 may be integrated with a sensor device (e.g., sensor device 260) that is coupled to a host (e.g., host 250).

Referring to FIGS. 1 through 6, the storage repository 631 may be a persistent storage device (or set of devices) that stores software and data used to assist the controller 604 in communicating with one or more other components of a system, such as the users 251 (including associated user systems 255), the network manager 280, the controllers 204, the sensor devices 160, one or more sensor devices (e.g., sensor devices 260, sensor devices 360, sensor devices 460, sensor devices 560) of an example subsea wellhead fatigue damage evaluation system (e.g., subsea wellhead fatigue damage evaluation system 225, subsea wellhead fatigue damage evaluation system 325), one or more hosts (e.g., host 250, host 350, host 450, host 550) of an example subsea wellhead fatigue damage evaluation system, and any other component of a system (e.g., system 200, system 300). In one or more example embodiments, the storage repository 631 stores one or more protocols 632, one or more algorithms 633, and stored data 634.

The protocols 632 of the storage repository 631 may be any procedures (e.g., a series of method steps) and/or other similar operational processes that the control engine 606 of the controller 604 follows based on certain conditions at a point in time. The protocols 632 may include any of a number of communication protocols that are used to send and/or obtain data between the controller 604 and other components of a system (e.g., the system 200). Such protocols 632 used for communication may be a time-synchronized protocol. Examples of such time-synchronized protocols may include, but are not limited to, a highway addressable remote transducer (HART) protocol, a wirelessHART protocol, and an International Society of Automation (ISA) 100 protocol. In this way, one or more of the protocols 632 may provide a layer of security to the data transferred within a system (e.g., system 200). Other protocols 632 used for communication may be associated with the use of Wi-Fi, Zigbee, visible light communication (VLC), cellular networking, BLE, UWB, and Bluetooth.

The algorithms 633 may be or include any formulas, mathematical models, forecasts, simulations, and/or other similar tools that a component (e.g., the control engine 606, the evaluation module 636) of the controller 604 uses to reach a computational conclusion. For example, one or more algorithms 633 may be used, in conjunction with one or more protocols 632, to assist the controller 604 to obtain values associated with measurements of a parameter made by one or more of the sensor devices (e.g., sensor devices 260, sensor devices 360, sensor devices 460, sensor devices 560) of an example subsea wellhead fatigue damage evaluation system (e.g., subsea wellhead fatigue damage evaluation system 225, subsea wellhead fatigue damage evaluation system 325). As another example, one or more algorithms 633 may be used, in conjunction with one or more protocols 632, to assist the controller 604 to use the values associated with the measurements to generate a result (e.g., a numeric value, a range of probabilities, an amount of fatigue damage of a subsea wellhead (e.g., subsea wellhead 240, subsea wellhead 340).

As yet another example, one or more algorithms 633 may be used, in conjunction with one or more protocols 632, to assist the controller 604 to compare the result of an algorithm 633 with a range of acceptable values (e.g., stored data 634), where the range of acceptable values is established using prior results (e.g., stored data 634) of the algorithm 633. As still another example, one or more algorithms 633 may be used, in conjunction with one or more protocols 632, to assist the controller 604 to determine an amount of fatigue damage (or some equivalent, such as a projected remaining useful life) of a subsea wellhead (e.g., subsea wellhead 240, subsea wellhead 340, subsea wellhead 440).

As yet another example, one or more algorithms 633 may be used, in conjunction with one or more protocols 632, to assist the controller 604 to develop a transfer function (a type of algorithm 633) relating the displacement at the top of the subsea wellhead to hot spot stress on the subsea assembly (e.g., subsea assembly 299). As still another example, one or more algorithms 633 may be used, in conjunction with one or more protocols 632, to assist the controller 604 to calculate the fatigue damage to a subsea wellhead, including an associated casing string. As yet another example, one or more algorithms 633 may be used, in conjunction with one or more protocols 632, to assist the controller 604 to make specific recommendations as to what portions of a subsea wellhead needs maintenance, repair, and/or replacement. An algorithm 633 may be or be based on machine learning and/or an analytical model.

Stored data 634 may be any data associated with the various equipment (e.g., a subsea wellhead 240, a host 350, a sensor device 460), including associated components, of the system 200, the example the subsea wellhead fatigue damage evaluation system (e.g., subsea wellhead fatigue damage evaluation system 225, subsea wellhead fatigue damage evaluation system 325), the user systems 255, the network manager 280, the controllers 204, the sensor devices (e.g., sensor devices 160, sensor devices 260, sensor devices 360, sensor devices 460, sensor devices 560), the hosts (e.g., host 250, host 350, host 450, host 550) of an example subsea wellhead fatigue damage evaluation system, measurements made by the sensor devices (e.g., sensor devices 260, sensor devices 360), specifications of the sensor devices (e.g., camera specifications and capabilities), the stress amplification factor (SAF) and S-N curves of each wellhead, threshold values, ranges of acceptable values, tables, results of previously run or calculated algorithms 633, updates to protocols 632 and/or algorithms 633, user preferences, and/or any other suitable data. Such data may be any type of data, including but not limited to historical data, present data, and future data (e.g., forecasts). The stored data 634 may be associated with some measurement of time derived, for example, from the timer 635.

Examples of a storage repository 631 may include, but are not limited to, a database (or a number of databases), a file system, cloud-based storage, a hard drive, flash memory, some other form of solid-state data storage, or any suitable combination thereof. The storage repository 631 may be located on multiple physical machines, each storing all or a portion of the protocols 632, the algorithms 633, and/or the stored data 634 according to some example embodiments. Each storage unit or device may be physically located in the same or in a different geographic location.

The storage repository 631 may be operatively connected to the control engine 606. In one or more example embodiments, the control engine 606 includes functionality to communicate with the users 251 (including associated user systems 255), the controllers 204, the sensor devices 160, the sensor devices (e.g., sensor devices 260, sensor devices 360, sensor devices 460, sensor devices 560) of an example subsea wellhead fatigue damage evaluation system, the hosts (e.g., host 250, host 350, host 450, host 550) of an example subsea wellhead fatigue damage evaluation system, the network manager 280, and any other components in the system (e.g., system 200, system 300). More specifically, the control engine 606 sends information to and/or obtains information from the storage repository 631 in order to communicate with the users 251 (including associated user systems 255), the controllers 204, the sensor devices 160, the sensor devices of an example subsea wellhead fatigue damage evaluation system, the hosts (e.g., host 250, host 350, host 450, host 550) of an example subsea wellhead fatigue damage evaluation system, the network manager 280, and any other components of the system. As discussed below, the storage repository 631 may also be operatively connected to the communication module 607 in certain example embodiments.

In certain example embodiments, the control engine 606 of the controller 604 controls the operation of one or more components (e.g., the communication module 607, the timer 635, the transceiver 624) of the controller 604. For example, the control engine 606 may activate the communication module 607 when the communication module 607 is in “sleep” mode and when the communication module 607 is needed to send data obtained from another component (e.g., a sensor device 160, a controller 204) in a system (e.g., system 200, system 300). In addition, the control engine 606 of the controller 604 may control the operation of one or more other components (e.g., a sensor device 360, a controller 204), or portions thereof, of the system.

The control engine 606 of the controller 604 may communicate with one or more other components of the system (e.g., system 200, system 300). For example, the control engine 606 may use one or more protocols 632 to facilitate communication with the sensor devices (e.g., sensor devices 260, sensor devices 360, sensor devices 460, sensor devices 560) of an example subsea wellhead fatigue damage evaluation system to obtain data (e.g., measurements of various parameters, such as vibration, temperature, pressure, proximity, and flow rate), whether in real time or on a periodic basis and/or to instruct a sensor device to take a measurement. The control engine 606 may use measurements (including the associated values) of parameters taken by sensor devices to perform one or more steps in remotely evaluating a subsea wellhead (e.g., subsea wellhead 240, subsea wellhead 340, subsea wellhead 440) using one or more protocols 632 and/or one or more algorithms 633.

For instance, the control engine 606 may use one or more algorithms 633 and/or one or more protocols 632 to obtain values associated with measurements of one or more parameters associated with a subsea wellhead and/or an associated casing string (e.g., casing string 219, casing string 319). If the sensor device that made the measurement is not capable of generating an associated value for the measurement, then the control engine 606, using one or more algorithms 633, one or more protocols 632 and/or stored data 634, may generate values based on the measurements.

As still another example, the control engine 606 may use one or more algorithms 633 and/or one or more protocols 632 to use the values associated with the measurements to generate a result (e.g., a numeric value, a range of probabilities). As yet another example, the control engine 606 may use one or more algorithms 633 and/or one or more protocols 632 to compare the result of an algorithm 633 with a range of acceptable values (e.g., stored data 634), where the range of acceptable values is established using prior results (e.g., stored data 634) of the algorithm 633. As still another example, the control engine 606 may use one or more algorithms 633 and/or protocols 632 to determine that a subsea wellhead (e.g., subsea wellhead 240, subsea wellhead 340, subsea wellhead 440) has a potential failure when the result of an algorithm 633 falls outside the range of acceptable values.

As yet another example, the control engine 606 of the controller 604 may use one or more algorithms 633, in conjunction with one or more protocols 632, to develop a transfer function (a type of algorithm 633) relating the displacement at the top of the subsea wellhead to hot spot stress on the subsea assembly (e.g., subsea assembly 299). As still another example, the control engine 606 of the controller 604 may use one or more algorithms 633, in conjunction with one or more protocols 632, to calculate the fatigue damage to a subsea wellhead, including an associated casing string. As yet another example, the control engine 606 may use one or more algorithms 633 and/or one or more protocols 632 to make specific recommendations as to what portions of a subsea wellhead should receive maintenance and/or repair.

The control engine 606 may generate and process data associated with control, communication, and/or other signals sent to and obtained from the users 251 (including associated user systems 255), the controllers 204, the sensor devices 160, the sensor devices (e.g., sensor devices 260, sensor devices 360, sensor devices 460, sensor devices 560) of an example subsea wellhead fatigue damage evaluation system, the hosts (e.g., host 250, host 350, host 450, host 550) of an example subsea wellhead fatigue damage evaluation system, the network manager 280, and any other components of a system (e.g., system 200, system 300). In certain embodiments, the control engine 606 of the controller 604 may communicate with one or more components of a system external to the system (e.g., system 200, system 300). For example, the control engine 606 may interact with an inventory management system by ordering replacements for components or pieces of equipment (e.g., a sensor device 360, a control valve, a motor, part of a subsea wellhead) within the system that has failed or is failing. As another example, the control engine 606 may interact with a contractor or workforce scheduling system by arranging for the labor needed to replace a component or piece of equipment in the system. In this way and in other ways, the controller 604 is capable of performing a number of functions beyond what could reasonably be considered a routine task.

In certain example embodiments, the control engine 606 may include an interface that enables the control engine 606 to communicate with the controllers 204, the sensor devices 160, the sensor devices (e.g., sensor devices 260, sensor devices 360, sensor devices 460, sensor devices 560) of an example subsea wellhead fatigue damage evaluation system, the hosts (e.g., host 250, host 350, host 450, host 550) of an example subsea wellhead fatigue damage evaluation system, the user systems 255, the network manager 280, and any other components of a system (e.g., system 200, system 300). For example, if a user system 255 operates under IEC Standard 62386, then the user system 255 may have a serial communication interface that will transfer data to the controller 604. Such an interface may operate in conjunction with, or independently of, the protocols 632 used to communicate between the controller 604 and the users 251 (including corresponding user systems 255), the controllers 204, the sensor devices 160, the sensor devices (e.g., sensor devices 260, sensor devices 360, sensor devices 460, sensor devices 560) of an example subsea wellhead fatigue damage evaluation system, the hosts (e.g., host 250, host 350, host 450, host 550) of an example subsea wellhead fatigue damage evaluation system, the network manager 280, and any other components of a system.

The control engine 606 (or other components of the controller 604) may also include one or more hardware components and/or software elements to perform its functions. Such components may include, but are not limited to, a universal asynchronous receiver/transmitter (UART), a serial peripheral interface (SPI), a direct-attached capacity (DAC) storage device, an analog-to-digital converter, an inter-integrated circuit (I2C), and a pulse width modulator (PWM).

The evaluation module 636 of the controller 604 of a subsea wellhead fatigue damage evaluation system (e.g., subsea wellhead fatigue damage evaluation system 225, subsea wellhead fatigue damage evaluation system 225) may be configured to evaluate values associated with measurements of one or more sensor devices 160 and/or one or more sensor devices (e.g., sensor devices 260, sensor devices 360, sensor devices 460, sensor devices 560) of an example subsea wellhead fatigue damage evaluation system. The evaluation module 636 may use values associated with measurements of one or more parameters made by one or more sensor devices (e.g., sensor devices 260, sensor devices 360) to evaluate a subsea wellhead (e.g., subsea wellhead 240, subsea wellhead 340, subsea wellhead 440). Examples of such parameters may include, but are not limited to, vibration, signal characteristics (e.g., wavelength, amplitude, signal strength), flow rates, pressures, proximity, and temperatures. The evaluation module 636 may additionally or alternatively determine whether a subsea wellhead 240 (or portion thereof, such as the uppermost portion of a casing string (e.g., casing string 219, casing string 319)) is failing or has failed. The evaluation module 636 may use one or more protocols 632 and/or one or more algorithms 633 to perform any of its evaluations.

The compensation module 637 of the controller 604 of a subsea wellhead fatigue damage evaluation system (e.g., subsea wellhead fatigue damage evaluation system 225, subsea wellhead fatigue damage evaluation system 225) may be configured to make allowances and/or other forms of compensation for factors such as, but not limited to, turbulence experienced by one or more sensor devices (e.g., sensor devices 260, sensor devices 360, sensor devices 460, sensor devices 560) of an example subsea wellhead fatigue damage evaluation system, distances between a sensor device of an example subsea wellhead fatigue damage evaluation system and a subsea wellhead (e.g., subsea wellhead 240, subsea wellhead 340, subsea wellhead 440) and/or an associated casing string, and an angle formed between a sensor device of an example subsea wellhead fatigue damage evaluation system and a subsea wellhead and/or an associated casing string. The compensation module 637 may use one or more protocols 632, one or more algorithms 633, and/or stored data 634 to perform any of its functions.

The communication module 607 of the controller 604 determines and implements the communication protocol (e.g., from the protocols 632 of the storage repository 631) that is used when the control engine 606 communicates with (e.g., sends signals to, obtains signals from) the user systems 255, the controllers 204, the sensor devices 160, the sensor devices (e.g., sensor devices 260, sensor devices 360, sensor devices 460, sensor devices 560) of an example subsea wellhead fatigue damage evaluation system, the hosts (e.g., host 250, host 350, host 450, host 550) of an example subsea fatigue damage wellhead evaluation system, the network manager 280, and any other components of a system (e.g., system 200, system 300). In some cases, the communication module 607 accesses the stored data 634 to determine which communication protocol is used to communicate with another component of a system. In addition, the communication module 607 may identify and/or interpret the communication protocol of a communication obtained by the controller 604 so that the control engine 606 may interpret the communication. The communication module 607 may also provide one or more of a number of other services with respect to data sent from and obtained by the controller 604. Such services may include, but are not limited to, data packet routing information and procedures to follow in the event of data interruption.

The timer 635 of the controller 604 may track clock time, intervals of time, an amount of time, and/or any other measure of time. The timer 635 may also count the number of occurrences of an event, whether with or without respect to time. Alternatively, the control engine 606 may perform a counting function. The timer 635 is able to track multiple time measurements and/or count multiple occurrences concurrently. The timer 635 may track time periods based on an instruction obtained from the control engine 606, based on an instruction obtained from a user 251, based on an instruction programmed in the software for the controller 604, based on some other condition (e.g., the occurrence of an event) or from some other component, or from any combination thereof. In certain example embodiments, the timer 635 may provide a time stamp for each packet of data obtained from another component (e.g., a sensor device 360) of an example subsea wellhead fatigue damage evaluation system.

The power module 630 of the controller 604 obtains power from a power supply (e.g., AC mains, a battery) and manipulates (e.g., transforms, rectifies, inverts) that power to provide the manipulated power to one or more other components (e.g., the timer 635, the control engine 606) of the controller 604, where the manipulated power is of a type (e.g., alternating current, direct current) and level (e.g., 12V, 24V, 120V) that may be used by the other components of the controller 604. In some cases, the power module 630 may also provide power to one or more of the sensor devices (e.g., sensor devices 260, sensor devices 360, sensor devices 460, sensor devices 560) of an example subsea wellhead fatigue damage evaluation system and/or the hosts (e.g., host 250, host 350, host 450, host 550) of an example subsea wellhead fatigue damage evaluation system.

The power module 630 may include one or more of a number of single or multiple discrete components (e.g., transistor, diode, resistor, transformer) and/or a microprocessor. The power module 630 may include a printed circuit board, upon which the microprocessor and/or one or more discrete components are positioned. In addition, or in the alternative, the power module 630 may be a source of power in itself to provide signals to the other components of the controller 604. For example, the power module 630 may be or include an energy storage device (e.g., a battery). As another example, the power module 630 may be or include a localized photovoltaic power system.

The hardware processor 621 of the controller 604 executes software, algorithms (e.g., algorithms 633), and firmware in accordance with one or more example embodiments. Specifically, the hardware processor 621 may execute software on the control engine 606 or any other portion of the controller 604, as well as software used by the users 251 (including associated user systems 255), the network manager 280, and/or other components of a system. The hardware processor 621 may be an integrated circuit, a central processing unit, a multi-core processing chip, SoC, a multi-chip module including multiple multi-core processing chips, or other hardware processor in one or more example embodiments. The hardware processor 621 may be known by other names, including but not limited to a computer processor, a microprocessor, and a multi-core processor.

In one or more example embodiments, the hardware processor 621 executes software instructions stored in memory 622. The memory 622 includes one or more cache memories, main memory, and/or any other suitable type of memory. The memory 622 may include volatile and/or non-volatile memory. The memory 622 may be discretely located within the controller 604 relative to the hardware processor 621. In certain configurations, the memory 622 may be integrated with the hardware processor 621.

In certain example embodiments, the controller 604 does not include a hardware processor 621. In such a case, the controller 604 may include, as an example, one or more field programmable gate arrays (FPGA), one or more insulated-gate bipolar transistors (IGBTs), and/or one or more integrated circuits (ICs). Using FPGAs, IGBTs, ICs, and/or other similar devices known in the art allows the controller 604 (or portions thereof) to be programmable and function according to certain logic rules and thresholds without the use of a hardware processor. Alternatively, FPGAs, IGBTs, ICs, and/or similar devices may be used in conjunction with one or more hardware processors 621.

The transceiver 624 of the controller 604 may send and/or obtain control and/or communication signals. Specifically, the transceiver 624 may be used to transfer data between the controller 604 and the users 251 (including associated user systems 255), the controllers 204, the sensor devices 160, the sensor devices (e.g., sensor devices 260, sensor devices 360, sensor devices 460, sensor devices 560) of an example subsea wellhead fatigue damage evaluation system, the hosts (e.g., host 250, host 350, host 450, host 550) of an example subsea wellhead fatigue damage evaluation system, the network manager 280, and any other components of a system (e.g., system 200, system 300). The transceiver 624 may use wired and/or wireless technology. The transceiver 624 may be configured in such a way that the control and/or communication signals sent and/or obtained by the transceiver 624 may be obtained and/or sent by another transceiver that is part of a user system 255, a controller 204, a sensor device 160, a sensor device (e.g., a sensor device 260, a sensor device 360, a sensor device 460, a sensor device 560) of an example subsea wellhead fatigue damage evaluation system, a host (e.g., a host 250, a host 350, a host 450, a host 550) of an example subsea wellhead fatigue damage evaluation system, the network manager 280, and/or another component of a system (e.g., system 200, system 300). The transceiver 624 may send and/or obtain any of a number of signal types, including but not limited to radio frequency signals, infrared signals, ultrasonic signals, radar signals, and SONAR signals.

When the transceiver 624 uses wireless technology, any type of wireless technology may be used by the transceiver 624 in sending and obtaining signals. Such wireless technology may include, but is not limited to, Wi-Fi, Zigbee, VLC, cellular networking, BLE, UWB, and Bluetooth. The transceiver 624 may use one or more of any number of suitable communication protocols (e.g., ISA100, HART) when sending and/or obtaining signals.

Optionally, in one or more example embodiments, the security module 623 secures interactions between the controller 604, the users 251 (including associated user systems 255), the controllers 204, the sensor devices 160, the sensor devices (e.g., sensor devices 260, sensor devices 360, sensor devices 460, sensor devices 560) of an example subsea wellhead fatigue damage evaluation system, the hosts (e.g., host 250, host 350, host 450, host 550) of an example subsea wellhead fatigue damage evaluation system, the network manager 280, and any other components of a system (e.g., system 200, system 300). More specifically, the security module 623 authenticates communication from software based on security keys verifying the identity of the source of the communication. For example, user software may be associated with a security key enabling the software of a user system 255 to interact with the controller 604. Further, the security module 623 may restrict receipt of information, requests for information, and/or access to information.

A user 251 (including an associated user system 255), the controllers 204, the sensor devices 160, the sensor devices (e.g., sensor devices 260, sensor devices 360, sensor devices 460, sensor devices 560) of an example subsea wellhead fatigue damage evaluation system, the hosts (e.g., host 250, host 350, host 450, host 550) of an example subsea wellhead fatigue damage evaluation system, the network manager 280, and the other components of a system (e.g., system 200, system 300) may interact with the controller 604 using the application interface 626. Specifically, the application interface 626 of the controller 604 obtains data (e.g., information, communications, instructions, updates to firmware) from and sends data (e.g., information, communications, instructions) to the user systems 255 of the users 251, the controllers 204, the sensor devices 160, the sensor devices (e.g., sensor devices 260, sensor devices 360, sensor devices 460, sensor devices 560) of an example subsea wellhead fatigue damage evaluation system, the hosts (e.g., host 250, host 350, host 450, host 550) of an example subsea wellhead fatigue damage evaluation system, the network manager 280, and/or the other components of a system.

Examples of an application interface 626 may be or include, but are not limited to, an application programming interface, a web service, a data protocol adapter, some other hardware and/or software, or any suitable combination thereof. Similarly, the user systems 255 of the users 251, the controllers 204, the sensor devices 160, the sensor devices (e.g., sensor devices 260, sensor devices 360, sensor devices 460, sensor devices 560) of an example subsea wellhead fatigue damage evaluation system, the hosts (e.g., host 250, host 350, host 450, host 550) of an example subsea wellhead fatigue damage evaluation system, the network manager 280, and/or the other components of a system may include an interface (similar to the application interface 626 of the controller 604) to obtain data from and send data to the controller 604 in certain example embodiments.

In addition, as discussed above with respect to a user system 255 of a user 251, one or more of the controllers 204, one or more of the sensor devices 160, one or more of the sensor devices (e.g., sensor devices 260, sensor devices 360, sensor devices 460, sensor devices 560) of an example subsea wellhead fatigue damage evaluation system, one or more of the hosts (e.g., host 250, host 350, host 450, host 550) of an example subsea wellhead fatigue damage evaluation system, the network manager 280, and/or one or more of the other components of a system (e.g., system 200, system 300) may include a user interface. Examples of such a user interface may include, but are not limited to, a graphical user interface, a touchscreen, a keyboard, a monitor, a mouse, some other hardware, or any suitable combination thereof.

The controller 604, the users 251 (including associated user systems 255), the controllers 204, the sensor devices 160, the sensor devices (e.g., sensor devices 260, sensor devices 360, sensor devices 460, sensor devices 560) of an example subsea wellhead fatigue damage evaluation system, the hosts (e.g., host 250, host 350, host 450, host 550) of an example subsea wellhead fatigue damage evaluation system, the network manager 280, and the other components of a system (e.g., system 200, system 300) may use their own system or share a system in certain example embodiments. Such a system may be, or contain a form of, an Internet-based or an intranet-based computer system that is capable of communicating with various software. A computer system includes any type of computing device and/or communication device, including but not limited to the controller 604. Examples of such a system may include, but are not limited to, a desktop computer with a Local Area Network (LAN), a Wide Area Network (WAN), Internet or intranet access, a laptop computer with LAN, WAN, Internet or intranet access, a smart phone, a server, a server farm, an android device (or equivalent), a tablet, smartphones, and a personal digital assistant (PDA). Such a system may correspond to a computer system as described below with regard to FIG. 7.

Further, as discussed above, such a system may have corresponding software (e.g., user system software, sensor device software, controller software). The software may execute on the same or a separate device (e.g., a server, mainframe, desktop personal computer (PC), laptop, PDA, television, cable box, satellite box, kiosk, telephone, mobile phone, or other computing devices) and may be coupled by the communication network (e.g., Internet, Intranet, Extranet, LAN, WAN, or other network communication methods) and/or communication channels, with wire and/or wireless segments according to some example embodiments. The software of one system may be a part of, or operate separately but in conjunction with, the software of another system within and/or outside of a system (e.g., system 200, system 300).

FIG. 7 illustrates one embodiment of a computing device 718 that implements one or more of the various techniques described herein, and which is representative, in whole or in part, of the elements described herein pursuant to certain example embodiments. For example, a controller 604 (including components thereof, such as a control engine 606, a hardware processor 621, a storage repository 631, a power module 630, and a transceiver 624) may be considered a computing device 718. Computing device 718 is one example of a computing device and is not intended to suggest any limitation as to scope of use or functionality of the computing device and/or its possible architectures. Neither should the computing device 718 be interpreted as having any dependency or requirement relating to any one or combination of components illustrated in the example computing device 718.

The computing device 718 includes one or more processors or processing units 714, one or more memory/storage components 715, one or more input/output (I/O) devices 716, and a bus 717 that allows the various components and devices to communicate with one another. The bus 717 represents one or more of any of several types of bus structures, including a memory bus or memory controller, a peripheral bus, an accelerated graphics port, and a processor or local bus using any of a variety of bus architectures. The bus 717 includes wired and/or wireless buses.

The memory/storage component 715 represents one or more computer storage media. The memory/storage component 715 includes volatile media (such as random access memory (RAM)) and/or nonvolatile media (such as read only memory (ROM), flash memory, optical disks, magnetic disks, and so forth). The memory/storage component 715 includes fixed media (e.g., RAM, ROM, a fixed hard drive, etc.) as well as removable media (e.g., a Flash memory drive, a removable hard drive, an optical disk, and so forth).

One or more I/O devices 716 allow a user 251 to enter commands and information to the computing device 718, and also allow information to be presented to the user 251 and/or other components or devices. Examples of input devices 716 include, but are not limited to, a keyboard, a cursor control device (e.g., a mouse), a microphone, a touchscreen, and a scanner. Examples of output devices include, but are not limited to, a display device (e.g., a monitor or projector), speakers, outputs to a lighting network (e.g., DMX card), a printer, and a network card.

Various techniques are described herein in the general context of software or program modules. Generally, software includes routines, programs, objects, components, data structures, and so forth that perform particular tasks or implement particular abstract data types. An implementation of these modules and techniques are stored on or transmitted across some form of computer readable media. Computer readable media is any available non-transitory medium or non-transitory media that is accessible by a computing device. By way of example, and not limitation, computer readable media includes “computer storage media”.

“Computer storage media” and “computer readable medium” include volatile and non-volatile, removable and non-removable media implemented in any method or technology for storage of information such as computer readable instructions, data structures, program modules, or other data. Computer storage media include, but are not limited to, computer recordable media such as RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which is used to store the desired information and which is accessible by a computer.

The computer device 718 (also sometimes called a computer system 718 herein) is connected to a network (not shown) (e.g., a LAN, a WAN such as the Internet, cloud, or any other similar type of network) via a network interface connection (not shown) according to some example embodiments. Those skilled in the art will appreciate that many different types of computer systems exist (e.g., desktop computer, a laptop computer, a personal media device, a mobile device, such as a cell phone or personal digital assistant, or any other computing system capable of executing computer readable instructions), and the aforementioned input and output means take other forms, now known or later developed, in other example embodiments. Generally speaking, the computer system 718 includes at least the minimal processing, input, and/or output means necessary to practice one or more embodiments.

Further, those skilled in the art will appreciate that one or more elements of the aforementioned computer device 718 is located at a remote location and connected to the other elements over a network in certain example embodiments. Further, one or more embodiments are implemented on a distributed system having one or more nodes, where each portion of the implementation (e.g., the subsea wellhead fatigue damage evaluation system 225) is located on a different node within the distributed system. In one or more embodiments, the node corresponds to a computer system. Alternatively, the node corresponds to a processor with associated physical memory in some example embodiments. The node alternatively corresponds to a processor with shared memory and/or resources in some example embodiments.

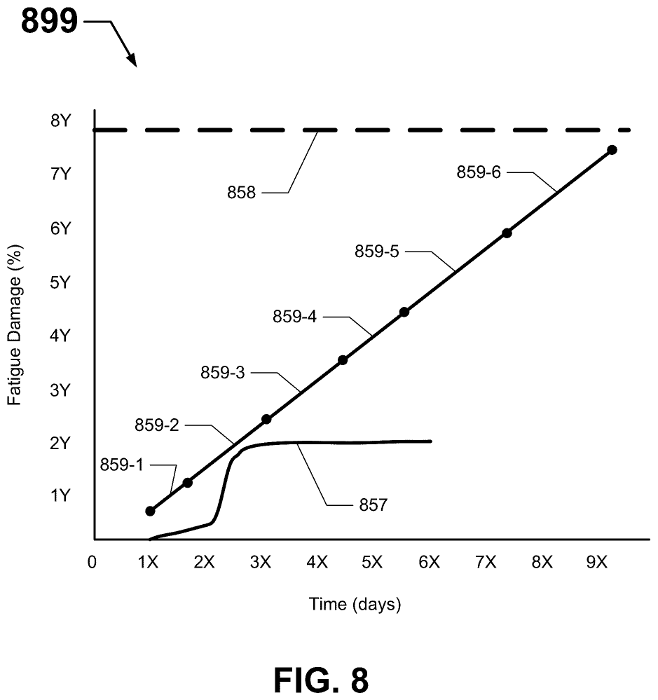

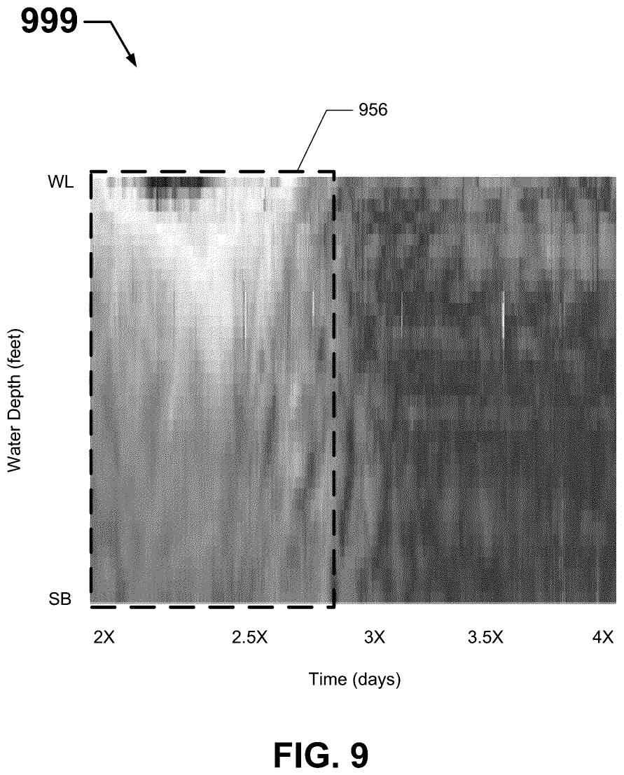

FIG. 8 shows a graph 899 illustrating evaluating a subsea wellhead certain example embodiments. FIG. 9 shows a graph 999 illustrating measured fatigue damage to a subsea wellhead relative to the graph of FIG. 8 valves according to certain example embodiments. Referring to FIGS. 1 through 9, the graph 899 of FIG. 8 shows three plots of fatigue damage (expressed as a percentage in increments of the variable “Y” along the vertical axis) of a subsea wellhead (e.g., subsea wellhead 240, subsea wellhead 340), which may also include the upper end of a casing string (e.g., casing string 219, casing string 319), over time (expressed in days in increments of the variable “X” along the horizontal axis) covering multiple stages of a drilling operation for a wellbore (e.g., wellbore 220). One plot 858 shows the maximum allowable fatigue damage of a wellhead of approximately 7.8Y over the duration of the entire drilling operation.

A second plot 859 shows the fatigue damage of a wellhead over the various stages of the drilling operation. The plot 859 is made up of discrete piece-wise linear segments. Segment 859-1, which corresponds to an initial casing section of the wellbore of 18 inches, starts at time 1X with an allowable fatigue damage of approximately 0.7Y and continues to approximately time 1.7X with an allowable fatigue damage of approximately 1.4Y. Segment 859-2, which corresponds to a subsequent casing section of the wellbore of 16 inches, starts at approximately time 1.7X with an allowable fatigue damage of approximately 1.4Y and continues to approximately time 3.1X with an allowable fatigue damage of approximately 2.5Y.

Segment 859-3, which corresponds to a subsequent casing section of the wellbore of 14 inches, starts at approximately time 3.1X with an allowable fatigue damage of approximately 2.5Y and continues to approximately time 4.4X with an allowable fatigue damage of approximately 3.5Y. Segment 859-4, which corresponds to a subsequent casing section of the wellbore of 11⅞ inches, starts at approximately time 4.4X with an allowable fatigue damage of approximately 3.5Y and continues to approximately time 5.7X with an allowable fatigue damage of approximately 4.5Y.

Segment 859-5, which corresponds to a subsequent casing section of the wellbore of 10.05 inches, starts at approximately time 5.7X with an allowable fatigue damage of approximately 4.5Y and continues to approximately time 7.8X with an allowable fatigue damage of approximately 6.2Y. Segment 859-6, which corresponds to a subsequent casing section of the wellbore of 11⅞ inches, starts at approximately time 7.8X with an allowable fatigue damage of approximately 6.2Y and continues to approximately time 9.3X with an allowable fatigue damage of approximately 7.5Y.

The final plot 857 shows actual fatigue damage as output by an example subsea wellhead fatigue damage evaluation system (e.g., subsea wellhead fatigue damage evaluation system 225, subsea wellhead fatigue damage evaluation system 325). Specifically, the plot 857 in the graph 899 of FIG. 8 is based, at least in part, on the data represented in the graph 999 of FIG. 9. The graph 999 of FIG. 9 plots current speed of water (e.g., water 294, water 494) with the vertical axis corresponding to the depth of the water (with WL being the water line (e.g., water line 193, water line 293) and with SB being the seabed (e.g., seabed 202, seabed 402)), and with the horizontal axis corresponding to time (in days). The time of the horizontal axis in the graph 999 of FIG. 9 coincides with the time of the horizontal axis in the graph 899 of FIG. 8.

As highlighted by the rectangular area 956, the graph 999 of FIG. 9 shows that the current speed from approximately time 1.9X to approximately time 2.8X is elevated (as shown by relatively lighter shades in the graph 999), particularly toward the water line. From approximately time 2.8X onward, the current speed at all depths in the water is negligible (as shown by the relatively darker shades in the graph 999). This information can be obtained from one or more sensor devices (e.g., sensor devices 160) that are configured to measure metocean data, such as current speed. In certain example embodiments, when the current speed at a depth (e.g., at the water line (as in this case), near the seabed) in the water reaches a threshold value (e.g., one knot), the controller 604 of an example subsea wellhead fatigue damage evaluation system (e.g., subsea wellhead fatigue damage evaluation system 225, subsea wellhead fatigue damage evaluation system 325) can instruct a sensor device (e.g., sensor device 260, sensor device 360, sensor device 460, sensor device 560) coupled to a host (e.g., host 250, host 350, host 450) to take measurements of one or more parameters (e.g., vibration) associated with a subsea wellhead (e.g., subsea wellhead 240, subsea wellhead 340), which may also include the upper end of a casing string (e.g., casing string 219, casing string 319).

Conversely, when the current speed at a depth in the water falls below the threshold value, the controller 604 of an example subsea wellhead fatigue damage evaluation system may instruct the sensor devices coupled to the hosts to not take any measurements. In alternative embodiments, when the current speed at a depth in the water falls below the threshold value, the controller 604 of an example subsea wellhead fatigue damage evaluation system may instruct the sensor devices coupled to the hosts to measurements at a lower frequency (e.g., once a day, once a week) compared to a higher frequency (e.g., every hour, continuously) when the current speed at a depth in the water reaches or exceeds the threshold value. In yet other alternative embodiments, the frequency at which measurements are made by a sensor device coupled to a host may be determined by three or more ranges of current speeds.

As a result of the one or more sensor devices coupled to one or more hosts taking measurements of the subsea wellhead, the controller 604 of an example subsea wellhead fatigue damage evaluation system may use these measurements to determine, using one or more algorithms 633 and/or protocols 632, the amount of fatigue damage of the subsea wellhead. Returning to the graph 899 of FIG. 8, the plot 857 begins at time 1X with no fatigue damage and terminates at approximately time 5.2X with estimated fatigue damage of approximately 2.2Y. The sharp rise in fatigue damage, beginning at approximately 0.3Y at approximately time 2.2X and ending at approximately 1.7Y at approximately time 2.6X, coincides with the sharp increase in current speed shown within the rectangular area 956 in the graph 999 of FIG. 9.

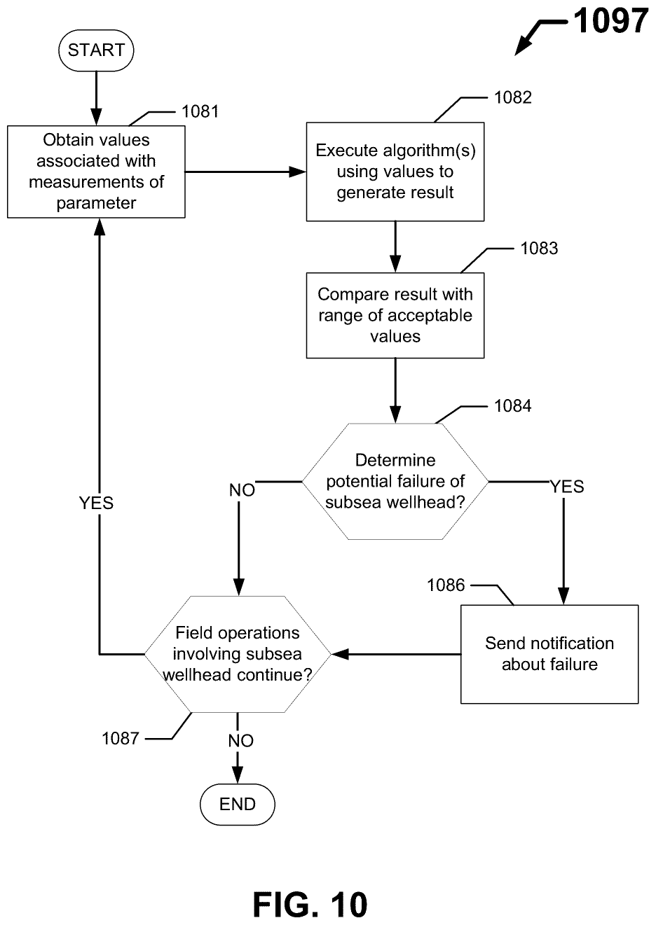

FIG. 10 shows a flowchart 1097 of a method for evaluating subsea wellheads according to certain example embodiments. While the various steps in this flowchart 1097 are presented sequentially, one of ordinary skill will appreciate that some or all of the steps may be executed in different orders, may be combined or omitted, and some or all of the steps may be executed in parallel. Further, in one or more of the example embodiments, one or more of the steps shown in this example method may be omitted, repeated, and/or performed in a different order.

In addition, a person of ordinary skill in the art will appreciate that additional steps not shown in FIG. 10 may be included in performing this method. Accordingly, the specific arrangement of steps should not be construed as limiting the scope. Further, a particular computing device, such as the computing device 718 discussed above with respect to FIG. 7, may be used to perform or facilitate performance of one or more of the steps (or portions thereof) for the method shown in FIG. 10 in certain example embodiments. Any of the functions (or portions thereof) performed below by a controller 604 may involve the use of one or more protocols 632, one or more algorithms 633, and/or stored data 634 stored in a storage repository 631. In addition, or in the alternative, any of the functions (or portions thereof) in the method may be performed by a user (e.g., user 251). In some cases, one or more of the various steps in the method of FIG. 10 may be performed automatically, as by a controller 604 of a subsea wellhead fatigue damage evaluation system (e.g., subsea wellhead fatigue damage evaluation system 225, subsea wellhead fatigue damage evaluation system 325).

The method shown in FIG. 10 is merely an example that may be performed by using an example system described herein. In other words, systems for evaluating subsea wellheads may perform other functions using other methods in addition to and/or aside from those shown in FIG. 10. Referring to FIGS. 1 through 10, the method shown in the flowchart 1097 of FIG. 10 begins at the START step and proceeds to step 1081, where values associated with measurements of one or more parameters are obtained. As used herein, the term “obtaining” may include receiving, retrieving, accessing, generating, etc. or any other manner of obtaining the information.

A parameter may include, but is not limited to, a vibration, one or more characteristics (e.g., amplitude, frequency, signal strength) of a received (e.g., reflected) signal, a pressure, a temperature, a chemical composition, and a flow rate. In certain example embodiments, the parameters may be associated with a subsea wellhead (e.g., subsea wellhead 240, subsea wellhead 340), which may also include the upper end of a casing string (e.g., casing string 219, casing string 319). Some or all of the values may be measured by one or more sensor devices (e.g., a sensor device 260, a sensor device 360). In addition, or in the alternative, some or all of the values may be calculated by a controller 604 of a subsea wellhead fatigue damage evaluation system (e.g., subsea wellhead fatigue damage evaluation system 225, subsea wellhead fatigue damage evaluation system 325) based on measurements of one or more parameters. The values may be continuous or discrete over a period of time (e.g., a second, a minute, an hour, a day, a week, a month).

The values may be obtained by a controller (or an obtaining component thereof), which may include the controller 604 of a subsea wellhead fatigue damage evaluation system (e.g., subsea wellhead fatigue damage evaluation system 225, subsea wellhead fatigue damage evaluation system 325), using one or more algorithms 633, one or more protocols 632, the communication module 607, the transceiver 624, and/or the application interface 626. The values may be obtained from a user 251, including an associated user system 255. In addition, or in the alternative, the values may be obtained from one or more sensor devices (e.g., sensor device 360) that measure one or more of the various parameters. In some cases, the controller 604 may be configured to receive raw measurements from a sensor device, and then subsequently derive values from the raw measurements.

In certain example embodiments, a trigger event may be used to start and/or stop the sensor devices (e.g., sensor devices 260, sensor devices 360, sensor devices 460, sensor devices 560) of an example subsea wellhead fatigue damage evaluation system from taking measurements of one or more parameters. For example, one or more other sensor devices (e.g., sensor devices 160) may be configured to measure the current speed in the water (e.g., water 294, water 494) in which the subsea wellhead is located. As a specific example, when the other sensor device (e.g., sensor device 160) measures a current speed near the water line to be less than 1 knot, then the controller 604 instructs the one or more sensor devices coupled to the one or more hosts of an example subsea wellhead fatigue damage evaluation system remain dormant (i.e., not take any measurements). When the other sensor device (e.g., sensor device 160) measures a current speed near the water line to be greater than 1 knot but less than 3 knots, then the controller 604 instructs the one or more sensor devices coupled to the one or more hosts of an example subsea wellhead fatigue damage evaluation system to take a measurement once every minute. When the other sensor device (e.g., sensor device 160) measures a current speed near the water line to be at least 3 knots, then the controller 604 instructs the one or more sensor devices coupled to the one or more hosts of an example subsea wellhead fatigue damage evaluation system to take measurements continuously.

In some cases, measurements and/or values derived from measurements made by one or more of the sensor devices 160 may be obtained. For example, sensor devices 160 in the form of, for example, strain gauges or motion sensors coupled to a subsea assembly (e.g., subsea assembly 299, subsea assembly 399) may take measurements that are obtained in this step 1081. The measurements and/or values derived from measurements made by one or more of the sensor devices 160 may be in addition to, but are not in place of, the measurements and/or values derived from measurements made by one or more of the sensor devices (e.g., sensor devices 260, sensor devices 360, sensor devices 460, sensor devices 560) coupled to a host (e.g., host 250, host 350, host 450) of an example subsea wellhead fatigue damage evaluation system (e.g., subsea wellhead fatigue damage evaluation system 225, subsea wellhead fatigue damage evaluation system 325).

To the extent that the host (e.g., host 250, host 350, host 450) to which one or more of the sensor devices (e.g., sensor devices 260, sensor devices 360, sensor devices 460, sensor devices 560) of an example subsea wellhead fatigue damage evaluation system are coupled are mobile, the host can be controlled (e.g., by the controller 604, by a user 251) so that the host, as well as the one or more associated sensor devices, are positioned properly relative to the subsea wellhead and associated casing string so that the sensor devices can take the measurements.

In certain example embodiments, factors such as, but not limited to, the distance 441 between a sensor device (e.g., sensor devices 260, sensor devices 360, sensor devices 460, sensor devices 560) and a portion of the subsea wellhead and/or casing string, and angle 442 between a sensor device and the portion of the subsea wellhead and/or the casing string 419 being targeted by the sensor device, and the turbulence 443 that is experienced by the combination of the sensor device and the host at the time that the sensor device is measuring a parameter may be accounted for in determining a value that is derived from a measurement. Such factors may be accounted for by the controller 604 using one or more algorithms 633, one or more protocols 632, and/or stored data 634. In addition, or in the alternative, such factors may be accounted for by a user 251 (including an associated user system 255), and/or the network manager 280.

In some cases, as when a sensor device (e.g., sensor devices 260, sensor devices 360, sensor devices 460, sensor devices 560) is in the form of a camera or other type of image-capturing device, the values may be derived from video clips or a series of still images captured by the camera. In some cases, one or more markers (e.g., marker 361, marker 461) may be used on the subsea wellhead and/or associated casing string in order to pinpoint a location on the subsea wellhead and/or associated casing string. Images captured by a camera or other type of image-capturing device may be analyzed by existing technologies (e.g., digital correlation, machine vision feature tracking) and/or by new technologies developed by an example subsea wellhead fatigue damage evaluation system.

In step 1082, one or more algorithms 633 are executed using the values to generate a result. The one or more algorithms 633 may be executed by the controller 604 of an example subsea wellhead fatigue damage evaluation system (e.g., subsea wellhead fatigue damage evaluation system 225, subsea wellhead fatigue damage evaluation system 325) above using one or more other algorithms 633, one or more protocols 632, and/or stored data 634. The values may include current values and/or historical (prior) values retrieved from the stored data 634. In some cases, one or more of the algorithms 633 may be modified (e.g., by the controller 604, by a user 251). For example, if the result generated is found to be (e.g., through subsequent manual inspection) or believed to be (e.g., using measurements of other sensor devices (e.g., sensor device 160, sensor device 260, sensor device 360) incorrect, one or more of the algorithms 633 may be modified in a way designed to eliminate the error.

In such cases, the one or more algorithms 633 may be modified by the controller 604 of an example subsea wellhead fatigue damage evaluation system (e.g., subsea wellhead fatigue damage evaluation system 225, subsea wellhead fatigue damage evaluation system 325) using one or more protocols 632, one or more other algorithms 633, and/or stored data 634. In addition, or in the alternative, an algorithm 633 may be modified by a user 251, including an associated user system 255. In some cases, one or more of the algorithms 633 may be modified based on a comparison of actual values versus forecast values for some parameter associated with the subsea wellhead (e.g., subsea wellhead 240, subsea wellhead 340), which may also include the upper end of a casing string (e.g., casing string 219, casing string 319).

In some cases, the one or more algorithms 633 executed to generate a result allows the evaluation module 636 (or other part) of the controller 604 of the subsea wellhead fatigue damage evaluation system to perform data analysis using one or more signatures of the subsea wellhead. For example, one or more of the algorithms 633 may use a number (e.g., six) of performance indicators of the subsea wellhead that are based on a vibrations of the subsea wellhead.

Examples of outputs of one or more of the algorithms 633 may include, but are not limited to, the standard deviation of the vibrations, the maximum value of the vibrations, the minimum value of the vibrations, the mean value of the vibrations, an integration of the vibrations with respect to time, and a derivative of the vibrations with respect to time.

In some cases, the evaluation module 636 (or other part) of the controller 604 of an example subsea wellhead fatigue damage evaluation system may be configured to filter out bad signatures or other forms of measurement or outputs (results) of an algorithm 633. Such a bad signature or output may be discovered by comparing it with historical (prior) results of the algorithm 633 for that subsea wellhead and/or for similar subsea wellheads. In some cases, the prior results of the algorithm 633 include prior values associated with the parameter measured by a sensor device (e.g., sensor device 260, sensor device 360) and that are associated with the subsea wellhead. In addition, or in the alternative, the prior results of the algorithm 633 include prior values associated with the parameter from other sensor devices, where the prior values are associated with another actuator of another subsea wellhead, and where the other subsea wellhead is used in another subterranean field operation. Example embodiments may include one or more algorithms 633 that are configured to filter out those bad signatures or outputs from being studied further.

In some cases, data associated with one or more subsea wellheads may be used collectively to evaluate one or more other subsea wellheads. In such cases, the subsea wellheads may have one or more common characteristics (e.g., be from the same manufacturer, have the same configuration, operate at the same depth in the water (e.g., water 294, water 494), be used in the same field operation, operate at the same pressure). In such cases, the performance data of those subsea wellheads may be substantially similar. In some cases, if the differences in one or more characteristics of different subsea wellheads are significant enough, some interpolation (e.g., scale adjustment, shifting) could be applied to allow the historical data between the subsea wellheads to be used in evaluating one of the subsea wellheads. As a result, the performance indicators of the same subsea wellhead on different wellhead assemblies (e.g., wellhead assembly 299, wellhead assembly 399) may be clustered. Outliers (found in step 1083 below) from these clusters may indicate deviated performance from normal behavior of the subsea wellhead that may be studied in more depth.

In certain example embodiments, the compensation module 637 of the controller 604 of a subsea wellhead fatigue damage evaluation system (e.g., subsea wellhead fatigue damage evaluation system 225, subsea wellhead fatigue damage evaluation system 225) may be used to make allowances and/or other forms of compensation for factors such as, but not limited to, turbulence experienced by one or more sensor devices (e.g., sensor devices 260, sensor devices 360, sensor devices 460, sensor devices 560) of an example subsea wellhead fatigue damage evaluation system, distances between a sensor device of an example subsea wellhead fatigue damage evaluation system and a subsea wellhead (e.g., subsea wellhead 240, subsea wellhead 340, subsea wellhead 440) and/or an associated casing string, and an angle formed between a sensor device of an example subsea wellhead fatigue damage evaluation system and a subsea wellhead and/or an associated casing string. The compensation module 637 may use one or more protocols 632, one or more algorithms 633, and/or stored data 634 to perform any of its functions.

The result output by the one or more algorithms 633 may include vibration frequency and vibration amplitude. When this information is available, one or more other algorithms 633 may determine one or more fatigue properties (e.g., strain) with respect to the subsea wellhead (e.g., subsea wellhead 240, subsea wellhead 340), which may also include the upper end of a casing string (e.g., casing string 219, casing string 319).

In step 1083, the result of step 1082 is compared with a range of acceptable values. The range of acceptable values may be part of the stored data 634. The comparison of the result to the range of acceptable values may be performed by the evaluation module 636 or the control engine 606 of the controller 604 of an example subsea wellhead fatigue damage evaluation system (e.g., subsea wellhead fatigue damage evaluation system 225, subsea wellhead fatigue damage evaluation system 325) using one or more other algorithms 633, one or more protocols 632, and/or stored data 634. In addition to the stored data 634, the comparison of the result to the range of acceptable values may be performed using one or more protocols 632 and/or one or more algorithms 633. The result and/or the range of acceptable values may be or include numbers, words, symbols, phrases, and/or any other type of designation.

In some cases, the range of acceptable values may be modified based on certain conditions. For example, the range of acceptable values may be adjusted based on repairs performed on the subsea wellhead relative to the potential failure. As another example, as fatigue damage worsens and/or an amount of operating time of the subsea wellhead is great, the range of acceptable values may be adjusted to avoid a catastrophic failure. Changes to a range of acceptable values may be made by the control engine 606 of the controller 604 of an example subsea wellhead fatigue damage evaluation system (e.g., subsea wellhead fatigue damage evaluation system 225, subsea wellhead fatigue damage evaluation system 325) using one or more other algorithms 633, one or more protocols 632, and/or stored data 634. In addition, or in the alternative, a range of acceptable values may be changed by a user 251 (including an associated user system 255) and/or the network manager 280.

In step 1084, a determination is made as to whether there is a failure (e.g., an actual failure, a potential failure) based on the amount of fatigue damage to the subsea wellhead (e.g., subsea wellhead 240, subsea wellhead 340, subsea wellhead 440) and/or an associated casing string. The determination as to whether there is a failure of the subsea wellhead may include details about the failure (e.g., precise location of the fatigue damage on the subsea wellhead and/or associated casing string, lateral versus longitudinal fatigue stress). In some cases, the determination as to whether there is a failure of the subsea wellhead may include the extent of the failure (e.g., likely functional for approximately the next month, completely inoperable).

The determination as to whether there is a failure of the subsea wellhead may be made by the evaluation module 636 or the control engine 606 of the controller 604 of the example subsea wellhead fatigue damage evaluation system using one or more other algorithms 633, one or more protocols 632, and/or stored data 634. In addition, or in the alternative, a user 251 (including an associated user system 255) may make the determination as to whether there is a failure of the subsea wellhead. The time history of the various indicators of the signatures of the subsea wellhead may be evaluated to show the development of operational issues of the subsea wellhead. Signatures of subsea wellhead may be processed on a regular basis and incorporated into the historical trends, range of acceptable values, updates to algorithms 633, etc. If there is a failure of the subsea wellhead, then the process proceeds to step 1086. If there is a failure of the subsea wellhead, then the process proceeds to step 1087.

In step 1086, a notification about the failure is sent. The notification may be sent by the control engine 606 of the controller 604 of the example subsea wellhead fatigue damage evaluation system using one or more other algorithms 633, one or more protocols 632, stored data 634, the communication module 607, the transceiver 624, and/or the application interface 626. The notification may be sent to one or more users 251 (including associated user systems 255) and/or the network manager 280. The notification may be in any format (e.g., text message, email, broadcast recording, flashing indicator light on a control panel) that is acceptable to the intended recipient.

In step 1087, a determination is made as to whether the field operations involving the subsea wellhead are continuing. The determination as to whether the field operations involving the subsea wellhead are continuing may be made by the controller 604 of the subsea wellhead fatigue damage evaluation system using one or more protocols 632, one or more other algorithms 633, stored data 634, input from a user 251 (including an associated user system 255), measurements made by one or more of the sensor devices (e.g., sensor devices 260, sensor devices 360), and/or any other information. In addition, or in the alternative, the determination as to whether the field operations involving the subsea wellhead are continuing may be made by a user 251 (including an associated user system 255). If the field operations involving the subsea wellhead are continuing, then the process reverts to step 1081. If the field operations involving the subsea wellhead have stopped, then the process proceeds to the END step.

Example embodiments may be used to capture, trend, and identify signatures of subsea wellheads. Example embodiments may use additional sensor devices to measure parameters. The values associated with these measurements may be used when executing one or more algorithms to help capture and trend the fatigue damage signatures of the subsea wellheads. Example embodiments may continually, or in discrete time increments, monitor conditions to make adjustments in real time. Example embodiments result in identifying failures and potential failures in subsea wellheads. In some cases, example embodiments may identify specific parts of a subsea wellhead or associated component (e.g., the top portion of a casing string) that have failed or are potentially failing. Example embodiments may also be used to result in more efficient operations of the subsea wellheads. Example embodiments may be used with new subsea wellheads and related equipment or retrofit to work with existing subsea wellheads and related equipment. Example embodiments may provide a number of benefits. Such benefits may include, but are not limited to, ease of use, short commissioning time, extending the life of a subsea wellhead, flexibility, configurability, and improved compliance with applicable industry standards and regulations.

Although embodiments described herein are made with reference to example embodiments, it should be appreciated by those skilled in the art that various modifications are well within the scope of this disclosure. Those skilled in the art will appreciate that the example embodiments described herein are not limited to any specifically discussed application and that the embodiments described herein are illustrative and not restrictive. From the description of the example embodiments, equivalents of the elements shown therein will suggest themselves to those skilled in the art, and ways of constructing other embodiments using the present disclosure will suggest themselves to practitioners of the art. Therefore, the scope of the example embodiments is not limited herein.

What is claimed is:

1. A method for remotely evaluating fatigue damage of a subsea wellhead, the method comprising:
obtaining a plurality of values associated with measurements of a parameter associated with the fatigue damage of the subsea wellhead during field operations, wherein the measurements are measured by a sensor device positioned separately from and adjacent to the subsea wellhead;
executing an algorithm using the plurality of values to generate a result;
comparing the result of the algorithm with a range of acceptable values; and
determining that the subsea wellhead has a potential failure when the result falls outside the range of acceptable values.

2. The method of claim 1, wherein the range of acceptable values is established using prior results of the algorithm, wherein the prior results of the algorithm include a plurality of prior values associated with the parameter from the plurality of sensor devices and that are associated with the subsea wellhead.

3. The method of claim 1, wherein the range of acceptable values is established using prior results of the algorithm, wherein the prior results of the algorithm include a plurality of prior values associated with the parameter from an alternative plurality of sensor devices, wherein the plurality of prior values are associated with an alternative subsea wellhead, and wherein the alternative subsea wellhead is used in the field operation of another wellbore.

4. The method of claim 1, further comprising:
sending a notification about the potential failure of the subsea wellhead.

5. The method of claim 1, wherein the range of acceptable values represent a range of vibrations of the subsea wellhead.

6. The method of claim 1, wherein the parameter is measured during a period of time when turbulence in the water exceeds a threshold value.

7. The method of claim 1, wherein the algorithm is generated using prior values associated with prior measurements of the parameter made by the sensor device.

8. The method of claim 1, wherein determining that the subsea wellhead has the potential failure comprises identifying particular problem with the subsea wellhead.

9. The method of claim 1, wherein the range of acceptable values is adjusted based on subsequent results of the algorithm using subsequent values of measurements associated with the parameter made by the sensor device.

10. The method of claim 1, wherein the range of acceptable values is adjusted based on repairs performed on the subsea wellhead relative to the potential failure.

11. A system for remotely evaluating fatigue damage of a subsea wellhead, the system comprising:
a sensor device that is configured to measure a parameter associated with the fatigue damage of the subsea wellhead during field operations, wherein the sensor device is coupled to a host that is positioned separately from and adjacent to the subsea wellhead; and
a controller communicably coupled to the sensor device, wherein the controller is configured to:
obtain a plurality of values associated with measurements of the parameter, wherein the measurements are measured by the sensor device;
execute an algorithm using the plurality of values to generate a result;
compare the result of the algorithm with a range of acceptable values, wherein the range of acceptable values is established using prior results of the algorithm; and
determine that the subsea wellhead has a potential failure when the result falls outside the range of acceptable values.

12. The system of claim 11, wherein the parameter comprises a vibration.

13. The system of claim 11, wherein the sensor device comprises a camera.

14. The system of claim 11, wherein the sensor device uses an active measurement method.

15. The system of claim 11, wherein the host comprises a structure mounted in the subsea floor adjacent to the subsea wellhead.

16. The system of claim 11, wherein the host comprises a subsea vehicle that is sent down to the subsea wellhead when turbulence in the water exceeds a threshold value.

17. The system of claim 11, wherein the algorithm requires a distance of the sensor device from the subsea wellhead and an angle of the sensor device relative to the subsea wellhead as additional inputs.

18. The system of claim 11, further comprising:
a second sensor device that is configured to measure the parameter from a different location relative to the sensor device and the subsea wellhead, wherein the second sensor device is positioned separately from and adjacent to the subsea wellhead.

19. The system of claim 18, wherein the algorithm is executed further using a second plurality of values associated with second measurements of the parameter made by the second sensor device to generate the result.

20. A non-transitory computer readable medium comprising computer readable program code, which when executed by a computer processor, enables the computer processor to:
facilitate obtaining a plurality of values associated with measurements of a parameter associated with fatigue damage of a subsea wellhead during field operations, wherein the measurements are measured by a sensor device positioned separately from and adjacent to the subsea wellhead;
facilitate executing an algorithm using the plurality of measurements to generate a result;
facilitate comparing the result of the algorithm with a range of acceptable values; and
facilitate determining that the subsea wellhead has a potential failure when the result falls outside the range of acceptable values.
